(19) United States
(12) Patent Application Publication
(10) Pub. No.: US 2026/0027464 A1
(43) Pub. Date: Jan. 29, 2026

(54) METHOD AND APPARATUS FOR PRESENTING VIRTUAL ITEM EXCHANGE SCHEMES, DEVICE, AND STORAGE MEDIUM

(71) Applicant: TENCENT TECHNOLOGY (SHENZHEN) COMPANY LIMITED, Shenzhen (CN)

(72) Inventor: Ziyi Wang, Shenzhen (CN)

(73) Assignee: TENCENT TECHNOLOGY (SHENZHEN) COMPANY LIMITED, Shenzhen (CN)

(21) Appl. No.: 19/343,129

(22) Filed: Sep. 29, 2025

Related U.S. Application Data
(63) Continuation of application No. PCT/CN2024/104386, filed on Jul. 9, 2024.

(30) Foreign Application Priority Data
Sep. 12, 2023 (CN) 202311178113.6

(51) Int. Cl. A63F 13/537

(52) U.S. Cl. CPC A63F 13/537

(57) ABSTRACT

A method, apparatus, and computer-readable storage medium for presenting virtual item exchange schemes in virtual environments. The method displays an exchange request control on a first virtual object's user interface to initiate virtual item exchange requests within a virtual camp. Based on trigger operations for the exchange request control, the first virtual object enters an item exchange state. The user interface then presents a virtual item exchange scheme that indicates predicted virtual item quantity changes for the first virtual object resulting from exchanges within the virtual camp. This approach enables informed decision-making for virtual item trading by providing predictive exchange outcomes before commitment to transactions.

### CROSS-REFERENCE TO RELATED APPLICATIONS

This application is a continuation application of International Application No. PCT/CN2024/104386 filed on Jul. 9, 2024 which claims priority to Chinese Patent Application No. 202311178113.6, filed with the China National Intellectual Property Administration on Sep. 12, 2023, the disclosures of each being incorporated by reference herein in their entireties.

### FIELD

The disclosure relates to the field of human-computer interaction technologies, a method and apparatus for presenting virtual item exchange schemes, a device, and a storage medium.

### BACKGROUND

A first-person shooting game (FPS) is an application based on a three-dimensional virtual environment. A user may control a virtual object in the virtual environment to complete actions such as walking, running, climbing, and shooting, and a plurality of users may group online to cooperatively complete a task in a same virtual environment.

In the related art, virtual items may be exchanged between members of a same virtual camp in a battle process due to lack of a virtual item or requirement for allocation of a virtual item. In an exchange process of the virtual items, the members may pre-communicate by using text or voice to learn virtual items and excess virtual items of the two parties. Then, an item provider can open a backpack, select a virtual item to be exchanged, and discard and mark the virtual item, and correspondingly, an item receiver picks up the virtual item at a designated position.

It is clear that communication efficiency of virtual item exchange between members of a same virtual camp in a battle process may be low and the process is complex in the related art.

### SUMMARY

Provided are a method and apparatus for presenting virtual item exchange schemes, a device, a storage medium, and a program product, which can implement predictive virtual item exchange management within virtual camps through user interface controls and quantity change forecasting.

According to some embodiments, a method for presenting virtual item exchange schemes, performed by a computer device, includes: displaying, on a user interface of a first virtual object, an exchange request control configured to initiate a virtual item exchange request within a virtual camp; controlling the first virtual object to enter an item exchange state based on a trigger operation for the exchange request control; and presenting, on the user interface, a first virtual item exchange scheme configured to indicate a predicted virtual item quantity change for the first virtual object resulting from exchange of virtual items within the virtual camp.

According to some embodiments, an apparatus for presenting virtual item exchange schemes, includes: at least one memory configured to store program code; and at least one processor configured to read the program code and operate as instructed by the program code, the program code including: display code configured to cause at least one of the at least one processor to display, on a user interface of a first virtual object, an exchange request control configured to initiate a virtual item exchange request within a virtual camp; control code configured to cause at least one of the at least one processor to control the first virtual object to enter an item exchange state based on a trigger operation for the exchange request control; and presentation code configured to cause at least one of the at least one processor to present, on the user interface, a first virtual item exchange scheme configured to indicate a predicted virtual item quantity change for the first virtual object resulting from exchange of virtual items within the virtual camp.

According to some embodiments, a non-transitory computer-readable storage medium, storing computer code which, when executed by at least one processor, causes the at least one processor to at least: display, on a user interface of a first virtual object, an exchange request control configured to initiate a virtual item exchange request within a virtual camp; control the first virtual object to enter an item exchange state based on a trigger operation for the exchange request control; and present, on the user interface, a first virtual item exchange scheme configured to indicate a predicted virtual item quantity change for the first virtual object resulting from exchange of virtual items within the virtual camp.

### BRIEF DESCRIPTION OF THE DRAWINGS

FIG. 1 shows a schematic diagram of a computer system according to some embodiments.

FIG. 2 shows a flowchart of a method for presenting virtual item exchange schemes according to some embodiments.

FIG. 3 shows a schematic diagram of an interface for presenting a virtual item exchange scheme according to some embodiments.

FIG. 4 shows a flowchart of a method for presenting virtual item exchange schemes according to another exemplary embodiment of this application.

FIG. 5 shows a schematic diagram of an interface for displaying a place control according to some embodiments.

FIG. 6 shows a schematic diagram of an interface for presenting a first virtual item exchange scheme according to some embodiments.

FIG. 7 shows a schematic diagram of an interface for controlling a first virtual object to synchronize a first virtual item exchange scheme according to some embodiments.

FIG. 8 shows a schematic diagram of an interface for controlling a first virtual object to discard an excess first virtual item according to some embodiments.

FIG. 9 shows a schematic diagram of an interface for updating an exchange application control to an application cancel control according to some embodiments.

FIG. 10 shows a schematic diagram of an interface for controlling a first virtual object and a second virtual object to perform virtual item exchange according to some embodiments.

FIG. 11 shows a flowchart of displaying first virtual item difference information according to some embodiments.

FIG. 12 shows a flowchart of synchronizing first virtual item difference information according to some embodiments.

FIG. 13 shows a flowchart of virtual item exchange within a virtual camp according to some embodiments.

FIG. 14 shows a flowchart of discarding an excess virtual item according to some embodiments.

FIG. 15 shows a structural block diagram of an apparatus for presenting virtual item exchange schemes according to some embodiments.

FIG. 16 shows a structural block diagram of a terminal according to some embodiments.

### DESCRIPTION OF EMBODIMENTS

FIG. 1 shows a schematic diagram of a computer system according to some embodiments. The computer system 100 includes: a first terminal 110, a server 120, and a second terminal 130.

An application 111 supporting a virtual environment is run in the first terminal 110. When the first terminal 110 runs the application 111, a user interface of the application 111 is displayed on a screen of the first terminal 110. The application 111 may be a multiplayer online battle program, and may be any one of a multiplayer online battle arena (MOBA) game, a simulation game (SLG), a massive multiplayer online role-playing game (MMORPG), or an FPS. In some embodiments, an example in which the application 111 is an FPS is used for description. The first terminal 110 is a terminal used by a first user 112. The first user 112 uses the first terminal 110 to control a first virtual object in a virtual environment to perform activities. The first virtual object may be referred to as a main controlled virtual object of the first user 112. The activities of the first virtual object include, but are not limited to, at least one of adjusting a body posture, crawling, walking, running, riding, flying, jumping, driving, picking, shooting, attacking, throwing, and casting a skill. By way of example, the first virtual object is a first virtual person such as a simulated person or a cartoon person.

An application 131 supporting a virtual environment is run in the second terminal 130. When the second terminal 130 runs the application 131, a user interface of the application 131 is displayed on a screen of the second terminal 130. The application 131 may be a multiplayer online battle program, and may be any one of an MOBA game, an SLG, an MMORPG, or an FPS. In some embodiments, an example in which the application 131 is an FPS is used for description. The second terminal 130 is a terminal used by a second user 132. The second user 132 uses the second terminal 130 to control a second virtual object in a virtual environment to perform activities, and the second virtual object may be referred to as a main controlled virtual character of the second user 132. By way of example, the second virtual object is a second virtual person such as a simulated person or a cartoon person.

In some embodiments, the first virtual object and the second virtual object are in a same virtual environment. In some embodiments, the first virtual object and the second virtual object may belong to a same virtual camp, a same virtual team, and a same virtual organization, and have a friend relationship or have a temporary communication permission. In some embodiments, the first virtual object and the second virtual object may belong to different virtual camps, different virtual teams, and different virtual organizations, or have an adversarial relationship.

In some embodiments, the applications installed on the first terminal 110 and the second terminal 130 may be same, or the applications installed on the two terminals are applications of a same type on different operating system platforms (Android or IOS). The first terminal 110 may generally refer to one of a plurality of terminals, and the second terminal 130 may generally refer to another one of the plurality of terminals. In some embodiments, only the first terminal 110 and the second terminal 130 are used as examples. The first terminal 110 and the second terminal 130 have a same or different device types. The device type includes: at least one of a smartphone, a tablet computer, an e-book reader, a moving picture experts group audio layer III (MP3) player, a moving picture experts group audio layer IV (MP4) player, a laptop portable computer, and a desktop computer.

FIG. 1 shows only two terminals. However, there are a plurality of other terminals that may access the server 120 in different embodiments. In some embodiments, one or more terminals are terminals corresponding to a developer. By installing a developing and editing platform for an application that supports a virtual environment in the terminal, the developer may edit and update the application on the terminal, and transmit an updated application installation package to the server 120 through a wired or wireless network. The first terminal 110 and the second terminal 130 may download the application installation package from the server 120 to update the application.

The first terminal 110, the second terminal 130, and another terminal are connected to the server 120 through a wired network or wireless network.

The server 120 includes at least one of one server, a server cluster including a plurality of servers, a cloud computing platform, and a virtualization center. The server 120 is configured to provide a backend service for an application that supports a three-dimensional virtual environment. In some embodiments, the server 120 is in charge of primary computing works, and the terminal is in charge of secondary computing works. Alternatively, the server 120 is in charge of secondary computing works, and the terminal is in charge of primary computing works. Alternatively, the server 120 and the terminal perform collaborative computing by using a distributed computing architecture.

In an example, the server 120 includes a memory 121, a processor 122, a user account database 123, a battle service module 124, and a user-oriented input/output (I/O) interface 125. The processor 122 is configured to load instructions stored in the server 120, and process data in the user account database 123 and the battle service module 124. The user account database 123 is configured to store data of user accounts used by the first terminal 110, the second terminal 130, and another terminal, such as avatars of the user accounts, nicknames of the user accounts, fighting power indexes of the user accounts, and service areas of the user accounts. The battle service module 124 is configured to provide a plurality of battle rooms for users to battle, such as a 1V1 battle room, a 3V3 battle room, a 5V5 battle room, or a 1V5 battle room. The user-oriented I/O interface 125 is configured to establish communication between the first terminal 110 and/or the second terminal 130 via a wireless network or a wired network for data exchange.

A method for presenting virtual item exchange schemes provided in this application is described in combination with the above introduction. The method may be performed by a server or a terminal or jointly by the server and the terminal.

In some embodiments, an example in which the first terminal 110 is configured to control a first virtual object, the second terminal 130 and other terminals are respectively configured to control another virtual object in a virtual camp, the another virtual object may be in an item exchange state, and the first terminal 110, the second terminal 130, and the other terminals perform cooperative computing. The first terminal 110 is configured to: display an exchange application control on a backpack interface of a first virtual object, the exchange application control being configured to trigger the first virtual object to initiate a virtual item exchange application within a virtual camp; control the first virtual object to enter an item exchange state in response to a trigger operation for the exchange application control; and present a first virtual item exchange scheme on the backpack interface, the first virtual item exchange scheme being configured for indicating a predicted virtual item quantity change result for the first virtual object resulted from virtual item exchange. The first terminal 110 obtains virtual item difference information of another virtual object in an item exchange state from the second terminal 130 and the other terminals, and the first terminal 110 obtains virtual item difference information of the first virtual object. The first terminal 110 determines virtual item exchange schemes applicable to the first virtual object and the another virtual object in the item exchange state based on the virtual item difference information, and further determines and displays a first virtual item exchange scheme. The first virtual item exchange scheme is configured for indicating a predicted virtual item quantity change result for the first virtual object after the another virtual object in the item exchange state performs the virtual item exchange scheme.

In some embodiments, an example in which the first terminal 110 is configured to control a first virtual object, the second terminal 130 and another terminal are respectively configured to control another virtual object in a virtual camp, the another virtual object may be in an item exchange state, and the first terminal 110, the second terminal 130, the other terminals, and the server 120 perform cooperative computing. The first terminal 110 is configured to: display an exchange application control on a backpack interface of a first virtual object, the exchange application control being configured to trigger the first virtual object to initiate a virtual item exchange application within a virtual camp; control the first virtual object to enter an item exchange state in response to a trigger operation for the exchange application control; and present a first virtual item exchange scheme on the backpack interface, the first virtual item exchange scheme being configured for indicating a predicted virtual item quantity change result for the first virtual object resulted from virtual item exchange. The server 120 obtains virtual item difference information of the first virtual object and another virtual object in an item exchange state respectively from the first terminal 110, the second terminal 130, and the other terminals, and the server 120 determines virtual item exchange schemes applicable to the first virtual object and the another virtual object in the item exchange state based on the virtual item difference information, and further determines a first virtual item exchange scheme. The server 120 transmits the first virtual item exchange scheme to the first terminal 110 to display the first virtual item exchange scheme. The first virtual item exchange scheme is configured for indicating a predicted virtual item quantity change result for the first virtual object after the another virtual object in the item exchange state performs the virtual item exchange scheme.

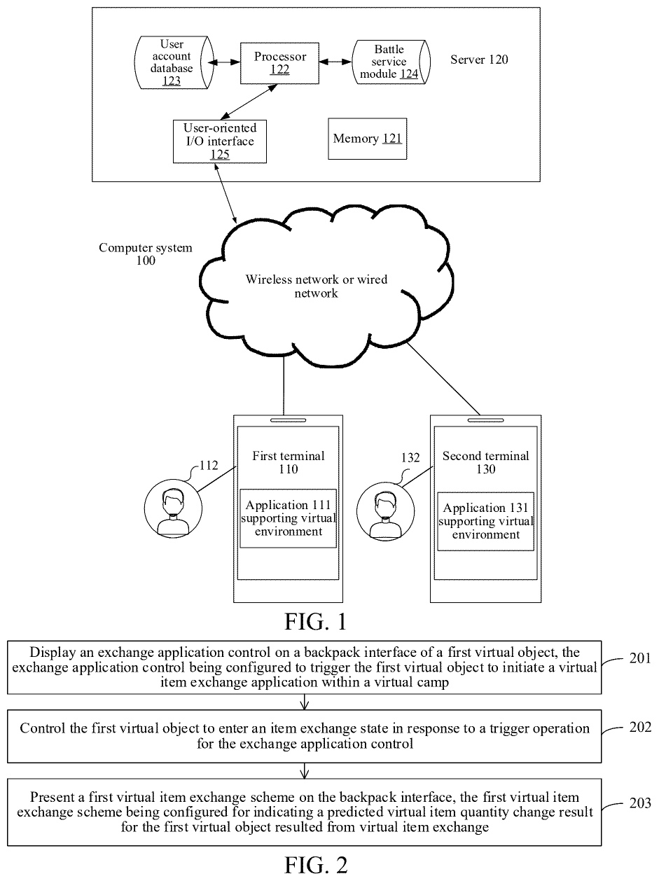

Some embodiments is described by using an example in which the method is performed by a terminal. FIG. 2 shows a flowchart of a method for presenting a virtual item exchange scheme according to some embodiments. Some embodiments is described by using an example in which the method is applied to the first terminal 110 or the second terminal 130 in an implementation environment shown in FIG. 1 or another terminal in the implementation environment. The method includes at least part of operation 201, operation 202, and operation 203.

Operation 201: Display an exchange application control on a backpack interface of a first virtual object, the exchange application control being configured to trigger the first virtual object to initiate a virtual item exchange application within a virtual camp.

In some embodiments, a virtual object is a movable object in a virtual environment. The movable object may be a virtual chess piece, a virtual person, a virtual animal, a cartoon person, or the like, such as a person, an animal, a plant, an oil drum, a wall, or a stone displayed in the virtual environment. In some embodiments, the virtual object is a three-dimensional spatial model created based on a skeletal animation technology. Each virtual object has a shape and a volume in the virtual environment, and occupies a part of a space in the virtual environment.

In some embodiments, a virtual battle refers to an activity in which a plurality of virtual objects interact in a virtual environment in a manner such as by using a virtual prop or casting a skill. In some embodiments, the virtual battle may be in a 1V1 battle or a 5V5 battle, or may be in a 1V5 dungeon monster-fighting mode. This is not limited in some embodiments.

In some embodiments, the virtual camp is a camp team formed by a plurality of virtual objects having a teammate relationship in a virtual battle.

In some embodiments, the backpack interface is configured for presenting virtual item information possessed by a virtual object in a current virtual battle to a player, and may include at least one of types, names, and a quantity of virtual items possessed by the virtual object. The virtual item may include at least one of virtual ammunitions, virtual accessories, and virtual medicines. This is not limited in some embodiments.

In some embodiments, to facilitate the first virtual object to perform virtual item exchange in the virtual camp, the terminal may display an exchange application control on a backpack interface of the first virtual object. The exchange application control is configured to trigger the first virtual object to initiate a virtual item exchange application within the virtual camp.

By way of example, the virtual item exchange application is an application triggered by the exchange application control and configured for applying to exchange at least one virtual item with at least one other virtual object within the virtual camp. The exchange may be obtaining a virtual item of another virtual object, or may be transmitting a virtual item of the current virtual object to another virtual object. In some embodiments, the exchange application control is displayed in a peripheral region of a virtual item possessed by the first virtual object, for example, located in an upper region or a lower region of the virtual item possessed by the first virtual object. The exchange application control may alternatively be named, for example, a first control or an application control, which may be needed to trigger the first virtual object to initiate a virtual item exchange application within the virtual camp.

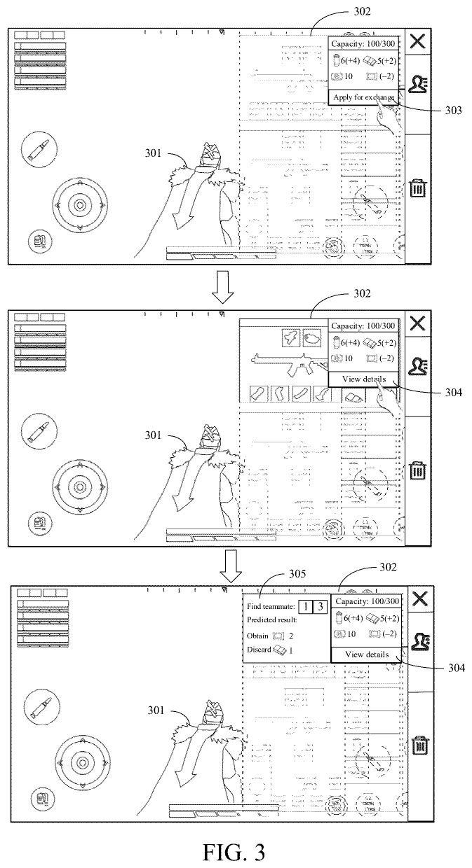

By way of example, as shown in FIG. 3, the terminal displays an exchange application control 303 on a backpack interface 302 of a first virtual object 301. The exchange application control 303 is displayed in a lower region of a virtual item possessed by the first virtual object 301.

Operation 202: Control the first virtual object to enter an item exchange state in response to a trigger operation for the exchange application control.

In some embodiments, when receiving a trigger operation of a player for an exchange application control, the terminal may control the first virtual object to enter an item exchange state.

In some embodiments, the item exchange state is a state in which the first virtual object initiates virtual item exchange to another virtual object within the virtual camp. In a case that the first virtual object enters the item exchange state, the another virtual object within the virtual camp that is also in the item exchange state may directly view and learn that the first virtual object currently has a virtual item exchange requirement.

In a possible implementation, to enable the another virtual object within the virtual camp to know that the first virtual object has an item exchange requirement, when the first virtual object enters the item exchange state, the terminal may further control the first virtual object to transmit a state entering notification to the another virtual object within the virtual camp.

In some embodiments, to improve efficiency of virtual item exchange between a plurality of virtual objects in an item exchange state, when controlling the first virtual object to enter the item exchange state, the terminal may further display an exchange details control on the backpack interface. The exchange details control is configured to view a first virtual item exchange scheme of the first virtual object.

In some embodiments, the exchange details control is displayed in a peripheral region of a virtual item possessed by the first virtual object, for example, located in an upper region or a lower region of the virtual item possessed by the first virtual object. The virtual item exchange schemes refer to exchange schemes applicable to the virtual objects in the item exchange state within the virtual camp, for possible exchanges of excess, lacking, or insufficient virtual items of the foregoing virtual objects. The first virtual item exchange scheme of the first virtual object is configured for indicating a predicted virtual item quantity change result for the first virtual object resulted from virtual item exchange.

For example, if excess virtual items of the first virtual object are 2 medical kits, the virtual item exchange scheme may be that the 2 medical kits may be both provided to a second virtual object, or the second virtual object and a third virtual object are separately allocated with 1 medical kit. The first virtual item exchange scheme displayed by the first virtual object is that 2 medical kits are predicted to be discarded, and 0 other medicines are predicted to be obtained. The exchange details control may alternatively be named, for example, a second control or a details control, which may be needed to implement viewing the first virtual item exchange scheme.

In some embodiments, the terminal further displays an exchange details control on the backpack interface. The exchange details control is configured to view the first virtual item exchange scheme of the first virtual object. The terminal further presents the first virtual item exchange scheme on the backpack interface in response to a trigger operation for the exchange details control.

In some embodiments, the trigger operation of the player for the exchange application control may be a click/tap operation, a touch and hold operation, or another possible operation manner.

In some embodiments, to save a control display space of the backpack interface, the terminal may further directly update the exchange application control to the exchange details control after receiving the trigger operation of the player for the exchange application control.

A manner of displaying and triggering the controls is not limited in some embodiments.

By way of example, as shown in FIG. 3, in a case that a click/tap operation of a player for the exchange application control 303 is received, the terminal controls the first virtual object 301 to enter an item exchange state, and updates the exchange application control 303 to an exchange details control 304 on the backpack interface 302, to display the exchange details control 304.

Operation 203: Present a first virtual item exchange scheme on the backpack interface, the first virtual item exchange scheme being configured for indicating a predicted virtual item quantity change result for the first virtual object resulted from virtual item exchange.

In some embodiments, when receiving a trigger operation of the player for the exchange details control, the terminal presents a first virtual item exchange scheme corresponding to the first virtual object to the player on the backpack interface. Thus, the player may learn, by using the first virtual item exchange scheme in time, a predicted virtual item quantity change result for the first virtual object if virtual objects in an item exchange state within a current virtual battle perform virtual item exchange.

In some embodiments, to enable the player to learn a virtual object within the virtual camp that enters an item exchange state, the first virtual item exchange scheme may further include object information of another virtual object within the virtual camp in the item exchange state, for example, at least one of an object number, an identifier, an avatar, and position information of the virtual object.

In some embodiments, to enable the player to learn virtual items to be obtained by the first virtual object and virtual items to be discarded if virtual item exchange is performed, the first virtual item exchange scheme is configured for indicating a predicted virtual item quantity change result for the first virtual object resulted from the virtual item exchange, for example, an item identifier and an item quantity of a virtual item that may be obtained, or an item identifier and an item quantity of a virtual item that may be discarded.

By way of example, as shown in FIG. 3, in a case that a click/tap operation of the player for the exchange details control 304 is received, the terminal displays a first virtual item exchange scheme 305 corresponding to the first virtual object 301 on the backpack interface 302. The first virtual item exchange scheme 305 includes object information of another virtual object in an item exchange state within the virtual camp, an object number 13. In addition, when the first virtual object performs virtual item exchange, a predicted virtual item quantity change result is that 2 virtual items of a type may be obtained, and 1 virtual item of another type may be discarded.

In conclusion, an exchange application control is additionally displayed on a backpack interface of a first virtual object. Thus, in a case that a trigger operation for the exchange application control is received, the first virtual object may be controlled to enter an item exchange state, and a first virtual item exchange scheme may be presented on the backpack interface. Thus, the first virtual object may learn, without text or voice communication, a predicted virtual item quantity change result for the first virtual object resulted from virtual item exchange, to omit a virtual item communication process between virtual objects, thereby improving efficiency of virtual item exchange between virtual objects within a virtual camp. In some embodiments, to improve accuracy of the first virtual item exchange scheme, a relatively accurate virtual item exchange scheme within the virtual camp is provided for the first virtual object, the terminal further may determine corresponding virtual item exchange schemes applicable to the virtual objects according to virtual item possession situations of the virtual objects in an item exchange state within the virtual camp.

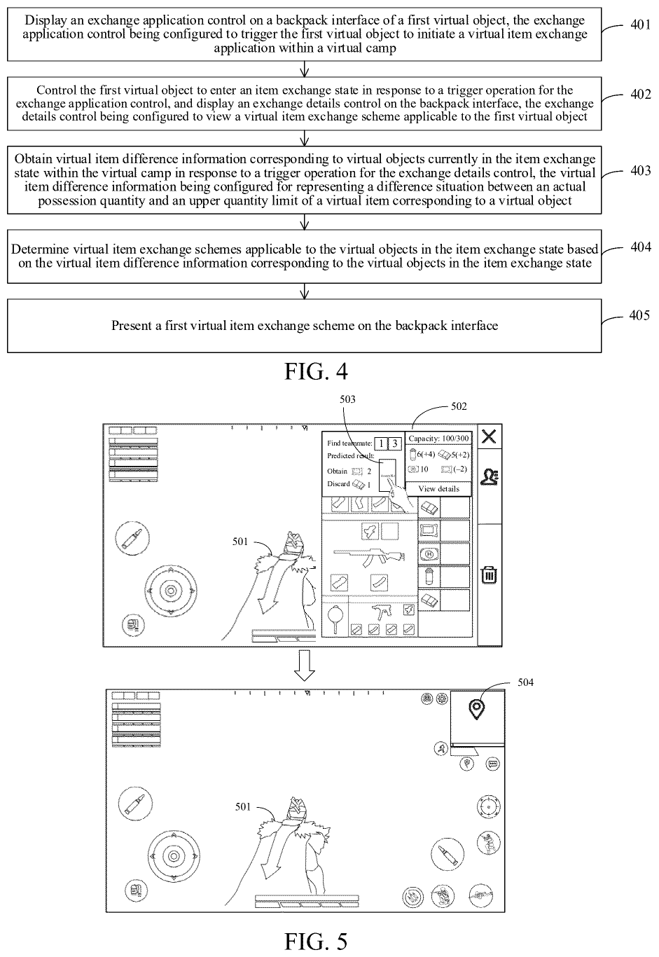

FIG. 4 shows a flowchart of a method for presenting a virtual item exchange scheme according to another exemplary embodiment of this application. Some embodiments is described by using an example in which the method is applied to the first terminal 110 or the second terminal 130 in an implementation environment shown in FIG. 1 or another terminal in the implementation environment. The method includes at least part of operation 401, operation 402, operation 403, operation 404, and operation 405.

Operation 401: Display an exchange application control on a backpack interface of a first virtual object, the exchange application control being configured to trigger the first virtual object to initiate a virtual item exchange application within a virtual camp.

Operation 402: Control the first virtual object to enter an item exchange state in response to a trigger operation for the exchange application control, and display an exchange details control on the backpack interface, the exchange details control being configured to view a virtual item exchange scheme applicable to the first virtual object.

For implementations of operations 401 and 402, refer to operations 201 and 202. Details are not described in some embodiments.

Operation 403: Obtain virtual item difference information corresponding to virtual objects currently in the item exchange state within the virtual camp in response to a trigger operation for the exchange details control, the virtual item difference information being configured for representing a difference situation between an actual possession quantity and an upper quantity limit of a virtual item corresponding to a virtual object.

In some embodiments, when receiving a trigger operation of a player for an exchange details control, the terminal may first determine virtual objects currently in an item exchange state within a virtual camp, and obtain virtual item difference information corresponding to the virtual objects. The virtual objects currently in the item exchange state within the virtual camp include the first virtual object.

In some embodiments, the virtual item difference information is configured for representing a difference situation between an actual possession quantity and an upper quantity limit of a virtual item corresponding to a virtual object.

In some embodiments, an upper quantity limit of a virtual item is an optimal possession quantity of the virtual item for a virtual object in a virtual battle, and may be optimal possession quantities of the respective virtual items. In addition, the optimal possession quantities of the respective virtual items may be the same or may be different. In some other embodiments, the upper quantity limit may alternatively be an optimal possession quantity of all the virtual items.

For example, an upper quantity limit of a virtual item for a virtual object means that an optimal possession quantity of all the virtual items possessed by the virtual object is 100. For another example, an upper quantity limit of a virtual item for a virtual object means that optimal possession quantities of the respective virtual items possessed by the virtual object are 30. For another example, an upper quantity limit of a virtual item for a virtual object means that optimal possession quantities of the respective virtual items possessed by the virtual object are 15. In some embodiments, an example in which the upper quantity limit is optimal possession quantities of the respective virtual items is used for description.

In some embodiments, an upper quantity limit of a virtual item for a virtual object may be a value set by a player before a virtual battle, or may be a value preset by a terminal, or may be a value adjusted in real time based on a current battle situation of the virtual object. The current battle situation includes at least one of a current level, health points, kill count, and a win rate. This is not limited in some embodiments.

In some embodiments, an actual possession quantity of a virtual item for a virtual object is an actual quantity of the virtual item currently possessed by the virtual object in a virtual battle. The actual possession quantity may change in real time according to virtual item picking, discarding, and use situations of the virtual object in the virtual battle.

In an example, an upper quantity limit corresponding to a virtual item of the first virtual object is 10. If an actual possession quantity corresponding to the virtual item of the first virtual object is 15, a virtual item difference corresponding to the virtual item of the first virtual object is plus 5. If an actual possession quantity corresponding to the virtual item of the first virtual object is 5, a virtual item difference corresponding to the virtual item of the first virtual object is minus 5.

In a possible implementation, when receiving a trigger operation of a player for an exchange details control, the terminal first determines object information of virtual objects currently in an item exchange state within a virtual camp, for example, at least one of object numbers, identifiers, and avatars of the virtual objects, obtains actual possession quantities and upper quantity limits of virtual items corresponding to the virtual objects in the item exchange state, and then subtracts the upper quantity limit from the actual possession quantity of the virtual item, to obtain virtual item difference information corresponding to the virtual item, thereby calculating virtual item difference information corresponding to the virtual objects currently in the item exchange state within the virtual camp.

Operation 404: Determine virtual item exchange schemes applicable to the virtual objects in the item exchange state based on the virtual item difference information corresponding to the virtual objects in the item exchange state.

In some embodiments, after obtaining the virtual item difference information corresponding to the virtual objects in the item exchange state, the terminal may determine virtual item exchange schemes applicable to the virtual objects in the item exchange state according to the actual possession quantities and upper quantity limits of the virtual items of the virtual objects.

In some embodiments, the terminal may first collect statistics on a to-be-exchanged virtual item currently within the virtual camp, including a type and an exchange quantity of the to-be-exchanged virtual item, according to the virtual item difference information corresponding to the virtual objects in the item exchange state. The to-be-exchanged virtual item is a virtual item having an actual possession quantity greater than an upper quantity limit among the virtual items possessed by the virtual objects in the item exchange state. The exchange quantity of the to-be-exchanged virtual item is a difference between the actual possession quantity and the upper quantity limit. For example, virtual items are medical kits and bandages. The first virtual object currently possesses 5 medical kits, and the upper quantity limit of the medical kits is 3. The first virtual object currently possesses 3 bandages, and the upper quantity limit of the bandages is 5. Then, there are 2 excess medical kits for the first virtual object. Therefore, to-be-exchanged virtual items of the first virtual object are 2 medical kits.

Further, the terminal may determine an item allocation quantity of the to-be-exchanged virtual item between the virtual objects in the item exchange state according to the virtual item difference information corresponding to the virtual objects, and a type and the exchange quantity of the to-be-exchanged virtual item, so as to generate virtual item exchange schemes corresponding to the virtual objects in the item exchange state.

In a possible implementation, in the presence of at least two virtual objects in the item exchange state within the virtual camp, the terminal may first determine, according to a type of a to-be-exchanged virtual item, a lack situation and a possession situation of the to-be-exchanged virtual item for the virtual objects in the item exchange state, and further determine a virtual item allocation quantity of the to-be-exchanged virtual item between the virtual objects in the item exchange state according to the exchange quantity of the to-be-exchanged virtual item and the lack situation and the possession situation of the to-be-exchanged virtual item for the virtual objects in the item exchange state.

In an example, virtual objects in an item exchange state within a virtual camp include a first virtual object and a second virtual object. First virtual item difference information of the first virtual object is that 1 first virtual item is lacked and 3 second virtual items are excess. Second virtual item difference information of the second virtual object is that 2 second virtual items are lacked. Thus, the terminal may determine that to-be-exchanged virtual items are the second virtual items, and a quantity of exchangeable second virtual items is 3. Further, the terminal may determine, according to the second virtual item difference information, that 2 second virtual items are allocated to the second virtual object.

In an example, virtual objects in an item exchange state within a virtual camp include a first virtual object, a second virtual object, and a third virtual object. First virtual item difference information of the first virtual object is that 1 first virtual item is lacked and 3 second virtual items are excess. Second virtual item difference information of the second virtual object is that 2 second virtual items are lacked and 2 third virtual items are excess. Third virtual item difference information of the third virtual object is that 1 second virtual item is lacked. Thus, the terminal may determine that to-be-exchanged virtual items are the second virtual items and the third virtual items. According to the to-be-exchanged virtual items and the first virtual item difference information, a virtual item allocation quantity corresponding to the first virtual object is 0. According to the to-be-exchanged virtual items and the second virtual item difference information, a virtual item allocation quantity corresponding to the second virtual object is 2 second virtual items. According to the to-be-exchanged virtual items and the third virtual item difference information, a virtual item allocation quantity corresponding to the third virtual object is 1 second virtual item. Neither the first virtual object nor the third virtual object lacks the third virtual items, the terminal may arbitrarily allocate the third virtual items to the first virtual object and the third virtual object, or may not allocate the third virtual items.

In some embodiments, considering that an exchange quantity of the to-be-exchanged virtual item may be relatively small, and item exchange requirements of the virtual objects in the item exchange state may not always be satisfied, to improve efficiency of exchanging the to-be-exchanged virtual item, the terminal may further determine priorities of allocating the to-be-exchanged virtual item to the virtual objects according to the actual possession quantity and/or lack quantity of the to-be-exchanged virtual item for the virtual objects, so that a quantity of exchanged virtual items of the virtual objects can satisfy a requirement of a virtual battle as much as possible.

In another implementation, the priority may alternatively be determined based on a current battle situation of the virtual objects. A poorer current battle situation indicates a higher priority. The current battle situation includes at least one of a current level, health points, kill count, and a win rate. For example, if a current health point of the second virtual object is minimum, the priority of the second virtual object is set to a highest priority, and a virtual item is exchanged with the second virtual object preferentially.

In a possible implementation, after the to-be-exchanged virtual items within the virtual camp are determined, the terminal may analyze virtual item difference information corresponding to the virtual objects in the item exchange state, determine an actual possession quantity of the to-be-exchanged virtual items for the virtual objects in the item exchange state, and preferentially determine a target virtual item allocation quantity of the to-be-exchanged virtual items corresponding to a first target virtual object in a case that an actual possession quantity of the to-be-exchanged virtual items for the first target virtual object is less than an actual possession quantity of the to-be-exchanged virtual items for another virtual object. The first target virtual object is any one of the virtual objects in the item exchange state. The target virtual item allocation quantity is a lack quantity of the first target virtual object for the to-be-exchanged virtual items.

In an example, virtual objects in an item exchange state within a virtual camp include a first virtual object, a second virtual object, and a third virtual object. First virtual item difference information of the first virtual object is that 1 first virtual item is lacked and 3 second virtual items are excess. Second virtual item difference information of the second virtual object is that 4 second virtual items are possessed, 2 second virtual items are lacked, but 2 third virtual items are excess. Third virtual item difference information of the third virtual object is that 1 second virtual item is possessed and 1 second virtual item is lacked. Thus, the terminal may determine that to-be-exchanged virtual items are the second virtual items and the third virtual items. The second virtual object and the third virtual object both lack the second virtual items. For the second virtual items, although the second virtual object still lacks 2 second virtual items compared with the upper quantity limit, 4 second virtual items have been possessed. Although the third virtual object lacks only 1 second virtual item compared with the upper quantity limit, only 1 second virtual item is possessed. The actual possession quantity of the second items for the second virtual object is greater than the actual possession quantity of the second items for the third virtual object. Therefore, for the second virtual items, the terminal may preferentially determine a target virtual item allocation quantity of the third virtual object, and then determine a target virtual item allocation quantity corresponding to the second virtual object.

In a possible implementation, not only actual possession quantities of the to-be-exchanged virtual items for the virtual objects may be considered, but also lack quantities of the to-be-exchanged virtual items for the virtual objects also may be considered. Thus, after determining the actual possession quantities of the to-be-exchanged virtual items for the virtual objects in the item exchange state and the lack quantities of the to-be-exchanged virtual items, the terminal may first compare the actual possession quantities of the to-be-exchanged virtual items for the virtual objects, and then compare the lack quantities of the to-be-exchanged virtual items. In some embodiments, the terminal may preferentially determine a target virtual item allocation quantity of the to-be-exchanged virtual items corresponding to the first target virtual object in a case that the actual possession quantity of the to-be-exchanged virtual items for the first target virtual object is equal to the actual possession quantity of the to-be-exchanged virtual items for the another virtual object and in a case that a lack quantity of the to-be-exchanged virtual items for the first target virtual object is greater than a lack quantity of the to-be-exchanged virtual items for the another virtual object.

In an example, virtual objects in an item exchange state within a virtual camp include a first virtual object, a second virtual object, and a third virtual object. First virtual item difference information of the first virtual object is that 1 first virtual item is lacked and 3 second virtual items are excess. Second virtual item difference information of the second virtual object is that 4 second virtual items are possessed, 2 second virtual items are lacked, but 2 third virtual items are excess. Third virtual item difference information of the third virtual object is that 4 second virtual items are possessed and 1 second virtual item is lacked. Thus, the terminal may determine that to-be-exchanged virtual items are the second virtual items and the third virtual items. The second virtual object and the third virtual object both lack the second virtual items. For the second virtual items, although the second virtual object still lacks 2 second virtual items compared with the upper quantity limit, 4 second virtual items have been possessed. Although the third virtual object further lacks 1 second virtual item compared with the upper quantity limit, 4 second virtual items have been possessed. The actual possession quantity of the second items for the second virtual object is equal to the actual possession quantity of the second items for the third virtual object. However, the lack quantity of the second virtual items for the second virtual object is greater than the lack quantity of the second virtual items for the third virtual object. Therefore, for the second virtual items, the terminal may preferentially determine a target virtual item allocation quantity of the second virtual object, and then determine a target virtual item allocation quantity corresponding to the third virtual object.

In some embodiments, the lack situation of the to-be-exchanged virtual items includes a lack quantity, and the possession situation of the to-be-exchanged virtual items includes an actual possession quantity. With reference to the foregoing embodiment, detailed determining operations of determining, by the terminal, virtual item exchange schemes applicable to the virtual objects in an item exchange state are as follows:
1) Collect statistics on virtual objects in an item exchange state within a virtual camp.
2) Collect statistics on types and exchange quantities of to-be-exchanged virtual items for the foregoing virtual objects.
3) Summarize types and exchange quantities of all to-be-exchanged virtual items.
4) Read a difference between an actual possession quantity and an upper quantity limit of each to-be-exchanged virtual item for the foregoing virtual objects.
5) Determine whether excess to-be-exchanged virtual items of each virtual object are lacked by other virtual objects, and determine a lack quantity of the other virtual objects and an actual possession quantity of the to-be-exchanged virtual items for the other virtual objects.
6) Determine a virtual item exchange scheme applicable to the foregoing virtual object. For an excess to-be-exchanged virtual item of a virtual object, another virtual object lacks the to-be-exchanged virtual item. If there is another virtual object, the excess to-be-exchanged virtual item is allocated to the another virtual object, and a virtual item allocation quantity is a lack quantity of the to-be-exchanged virtual item for the another virtual object. If there are a plurality of other virtual objects, the excess to-be-exchanged virtual item is preferentially allocated to another virtual object having a smaller actual possession quantity of the to-be-exchanged virtual item, and a virtual item allocation quantity is a lack quantity of the to-be-exchanged virtual item for the another virtual object. If actual possession quantities of the to-be-exchanged virtual item for a plurality of other virtual objects, the excess to-be-exchanged virtual item is preferentially allocated to another virtual object having a larger difference between an actual possession quantity and upper quantity limit, and a virtual item allocation quantity is a lack quantity of the to-be-exchanged virtual item for the another virtual object. If a plurality of other virtual objects correspond to the same difference, the excess to-be-exchanged virtual item is arbitrarily allocated to any other virtual object, and a virtual item allocation quantity is a lack quantity of the to-be-exchanged virtual item for the another virtual object. When the lack quantity of the to-be-exchanged virtual item is much greater than an exchange quantity of the to-be-exchanged virtual item, the maximum virtual item allocation quantity is the exchange quantity.
7) Determine whether there is still an excess to-be-exchanged virtual item waiting for virtual item exchange, if there is still an excess to-be-exchanged virtual item, determine actual possession quantities of the to-be-exchanged virtual item for all virtual objects, preferentially allocate to-be-exchanged virtual item to another virtual object having a smaller actual possession quantity, and if actual possession quantities for a plurality of other virtual objects are the same, arbitrarily allocate the to-be-exchanged virtual item to any other virtual object.

Operation 405: Present a first virtual item exchange scheme on the backpack interface.

In some embodiments, after determining virtual item exchange schemes applicable to the virtual objects in the item exchange state, the terminal may present a first virtual item exchange scheme on the backpack interface. The first virtual item exchange scheme includes object information corresponding to the virtual objects in the item exchange state, and the predicted virtual item quantity change result for the first virtual object when the virtual objects in the item exchange state perform virtual item exchange indicated by the virtual item exchange schemes. In some embodiments, the object information includes at least one of an object number, an identifier, an avatar, and position information of a virtual object. The terminal in some embodiments does not may display content of the virtual item exchange schemes applicable to the virtual objects in the item exchange state, and only presents the first virtual item exchange scheme.

However, considering that a virtual environment constantly changes, virtual objects in an item exchange state within a same virtual camp may be far apart. Consequently, virtual item exchange cannot be performed at the same time. For example, in a case that a first virtual object, a second virtual object, and a third virtual object are all in the item exchange state, the first virtual object is relatively close to the second virtual object, and the third virtual object is relatively far from the first virtual object and the second virtual object. Therefore, it is more convenient to perform virtual item exchange between the first virtual object and the second virtual object. However, if only the first virtual object, the second virtual object, and the third virtual object participating in the virtual item exchange is displayed on the backpack interface, in the first virtual item exchange scheme corresponding to the first virtual object, a player cannot comprehensively learn a virtual item quantity change result of the first virtual object in different virtual item exchange situations.

In a possible implementation, in the presence of at least two virtual objects in the item exchange state other than the first virtual object within the virtual camp, to assist the player in learning the virtual item quantity change result of the first virtual object in different virtual item exchange situations, the terminal may present a target virtual item exchange scheme on the backpack interface in response to a trigger operation performed by the player for target object information. The target object information is selected object information of the object information of the at least two virtual objects in the item exchange state. The target virtual item exchange scheme is configured for indicating a predicted virtual item quantity change result resulted from virtual item exchange between the first virtual object and a virtual object corresponding to the target object information. In some embodiments, the target virtual exchange scheme further includes target object information.

In an example, in a case that a first virtual object, a second virtual object, and a third virtual object are all in an item exchange state, when receiving a trigger operation of a player for an exchange details control, the terminal first presents a first virtual item exchange scheme. The first virtual item exchange scheme includes respective object information of the first virtual object, the second virtual object, and the third virtual object, and a virtual item quantity change result of the first virtual object in a case that the first virtual object, the second virtual object, and the third virtual object all participate in virtual item exchange. Further, when receiving a trigger operation of the player for the object information of the second virtual object, the terminal presents a target virtual item exchange scheme between the first virtual object and the second virtual object on the backpack interface. The target virtual item exchange scheme is a predicted virtual item quantity change result for the first virtual object when the third virtual object does not participate in virtual item exchange, and only the first virtual object and the second virtual object perform virtual item exchange.

In the foregoing embodiment, virtual item difference information of the virtual objects in the item exchange state within the virtual camp is determined, statistics on an exchange quantity of to-be-exchanged virtual items are collected according to the virtual item difference information of the virtual objects, and the to-be-exchanged virtual items are allocated, thereby improving the accuracy of the first virtual item exchange scheme, and optimizing the efficiency of virtual item exchange between the virtual objects.

In some embodiments, to improve a virtual item exchange speed of a virtual object within a virtual environment, in addition to presenting the first virtual item exchange scheme on the backpack interface, the terminal may further add a place control on the backpack interface. The place control is configured to trigger the first virtual object to initiate place assembling within the virtual camp.

In a possible implementation, the terminal may obtain position information of virtual objects in an item exchange state within a virtual environment, and determine a target moving place according to the position information of the virtual objects in the item exchange state, so that the terminal displays a place control on the backpack interface. The place control is configured to trigger the first virtual object to initiate place assembling within the virtual camp to move to the target moving place. Additionally, to enable players to find the target moving place more intuitively, when receiving a trigger operation for the place control, the terminal may further display place information of the target moving place on a virtual map. The place information is configured for instructing at least one other virtual object in the item exchange state to move toward the target moving place to perform virtual item exchange.

In some embodiments, the target moving place is a fixed position, or any one of positions of the virtual objects in the item exchange state, or a preset position. The preset position is equally distant from the positions of the virtual objects in the item exchange state, or a distance difference is less than a threshold.

In a possible implementation, considering that virtual objects in an item exchange state perform virtual item exchange with different urgencies, a virtual object having a relatively low current health point may may exchange a virtual item to improve the health point. If a target moving place is determined only according to position information of the virtual objects, the virtual object having a relatively low current health point cannot move to the target moving place, and virtual item exchange fails. Therefore, to improve appropriateness of determining the target moving place, in addition to according to the position information of the virtual objects, the terminal may further determine the target moving place between the virtual objects in the item exchange state according to attribute values of the virtual objects.

In some embodiments, the attribute value of a virtual object may be a health point, an attack value, or another value that affects a battle state of the virtual object. This is not limited in some embodiments.

In an example, a first virtual object, a second virtual object, and a third virtual object in an item exchange state exist within a virtual camp. A current health point of the third virtual object is relatively low. Thus, when determining a target moving place, the terminal may consider determining the target moving place to a place in a virtual environment, where a distance between the place and the third virtual object is less than a distance threshold.

By way of example, as shown in FIG. 5, after determining a target moving place between virtual objects in an item exchange state, the terminal displays a place control 503 on a backpack interface 502 of a first virtual object 501. The place control 503 is configured to trigger to display a position of the target moving place after clicking/tapping. Further, when receiving a trigger operation of a player for the place control 503, the terminal displays place information 504 of the target moving place on a virtual map.

In the foregoing embodiment, the place control is added to the backpack interface. A virtual object needing to perform virtual item exchange initiates place assembling within a virtual camp, and a target moving place is determined according to position information and an attribute value of the virtual object, so that the virtual objects in the item exchange state can quickly complete place assembling, and perform virtual item exchange, thereby improving the efficiency of virtual item exchange between the virtual objects in the virtual camp.

In some embodiments, to more intuitively learn a quantity of virtual items currently possessed by the first virtual object before the player controls the first virtual object to initiate a virtual item exchange application, the terminal may further first present first virtual item difference information of the first virtual object to the player on the backpack interface. The first virtual item difference information is configured for representing a difference situation between an actual possession quantity and an upper quantity limit of the virtual item corresponding to the first virtual object.

In a possible implementation, when receiving a viewing operation of the player for the backpack interface, the terminal first obtains an actual possession quantity and an upper quantity limit of the virtual item corresponding to the first virtual object, then determines first virtual item difference information corresponding to the first virtual object according to the actual possession quantity and the upper quantity limit of the virtual items, and displays the first virtual item difference information on the backpack interface.

In some embodiments, the first virtual item difference information may include the actual possession quantity of the virtual items corresponding to the first virtual object and a quantity difference between the actual possession quantity and the upper quantity limit.

In some embodiments, the upper quantity limit may be an upper possession limit value of the virtual items preset by the player for the first virtual object before a virtual battle, or may be preset by a system. This is not limited in some embodiments.

In a possible implementation, to optimize a space display effect within the backpack interface, and considering that virtual item exchange may be performed only when a virtual object lacks a virtual item, the terminal may display an exchange application control on the backpack interface in a case that an actual possession quantity of at least one virtual item for the first virtual object is less than the upper quantity limit. In a case that the first virtual object has no virtual item having an actual possession quantity less than the upper quantity limit, the exchange application control is not displayed.

In some embodiments, to make the player learn the first virtual item difference information of the first virtual object more intuitively and, the terminal may further display the first virtual item difference information in different states by using different display effects.

In a possible implementation, in a case that the actual possession quantity of the virtual item corresponding to the first virtual object is less than the upper quantity limit, the terminal may display the first virtual item difference information on the backpack interface by using a first display effect. In a case that the actual possession quantity of the virtual item corresponding to the first virtual object is greater than the upper quantity limit, the terminal may display the first virtual item difference information on the backpack interface by using a second display effect. In a case that the actual possession quantity of the virtual item corresponding to the first virtual object is equal to the upper quantity limit, the terminal may display the first virtual item difference information on the backpack interface by using a third display effect. In some embodiments, the first display effect, the second display effect, and the third display effect are different from each other, and may be different in terms of a display color or a display font. This is not limited in some embodiments.

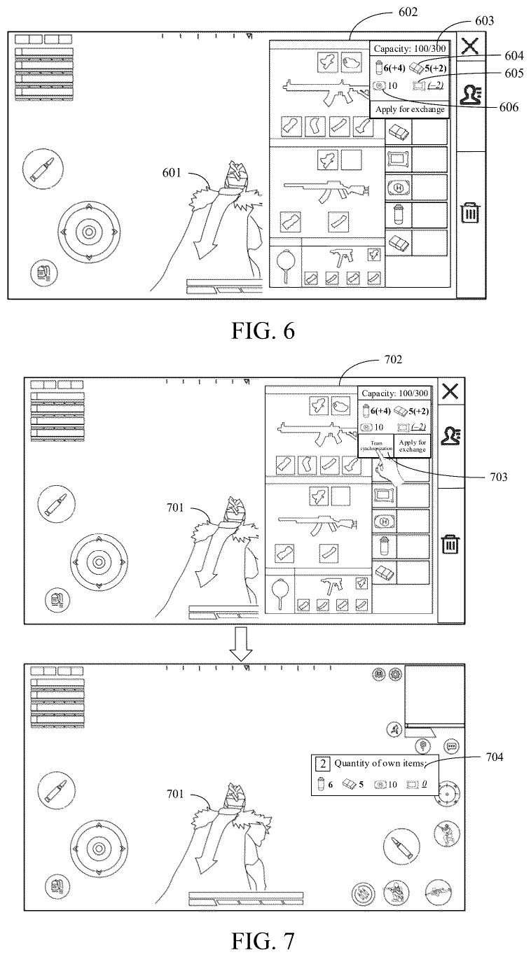

By way of example, as shown in FIG. 6, the terminal displays first virtual item difference information 603 corresponding to a first virtual object 601 on a backpack interface 602. A first actual possession quantity of a first virtual item 604 is 5 and is greater than a first upper quantity limit of the first virtual item 604 by 2. Therefore, the terminal displays first virtual item difference information corresponding to the first virtual item 604 by using a first display effect (bold font). A first actual possession quantity of a first virtual item 605 is 0 and is less than a first upper quantity limit of the first virtual item 605 by 2. Therefore, the terminal displays first virtual item difference information corresponding to the first virtual item 605 by using a second display effect (italic and underline). A first actual possession quantity of a first virtual item 606 is 10 and is equal to a first upper quantity limit of the first virtual item 606. Therefore, the terminal displays first virtual item difference information corresponding to the first virtual item 606 by using a third display effect (no bold, no italic, and no underline).

In the foregoing embodiment, the first virtual item difference information is displayed on the backpack interface, and the first virtual item difference information is displayed by using different display effects according to the actual possession quantities and upper quantity limits of the virtual items corresponding to the first virtual object, so that the player can learn current virtual item possession situations of the first virtual object more intuitively, thereby optimizing the display effect of virtual item information.

In some embodiments, considering that there may be only virtual objects lacking virtual items within the virtual camp, only the first virtual object among the virtual objects is in the item exchange state, even if the first virtual object is controlled to enter the item exchange state, virtual item exchange cannot be performed in time. To enable another virtual object within the virtual camp to quickly learn that the first virtual object has a virtual item exchange requirement, the terminal may further provide an information synchronization control on the backpack interface. The information synchronization control is configured to synchronize first virtual item difference information of the first virtual object to the another virtual object within the virtual camp. The first virtual item difference information is configured for representing a difference situation between an actual possession quantity and an upper quantity limit of the virtual item corresponding to the first virtual object.

In a possible implementation, in response to a trigger operation of the player for the information synchronization control, the terminal obtains first virtual item difference information corresponding to the first virtual object, and controls the first virtual object to transmit the first virtual item difference information to another virtual object within the virtual camp.

In a possible implementation, to make it convenient for another player to intuitively learn a lack situation of a current virtual item of the first virtual object after receiving the first virtual item difference information, when controlling the first virtual object to transmit the first virtual item difference information, the terminal may further set a display effect of the first virtual item difference information. For example, the first virtual item difference information is displayed by using a first display effect in a case that the actual possession quantity of the virtual item is less than the upper quantity limit. The first virtual item difference information is displayed by using a second display effect in a case that the actual possession quantity of the virtual item is greater than the upper quantity limit. The first virtual item difference information is displayed by using a third display effect in a case that the actual possession quantity of the virtual item is equal to the upper quantity limit.

By way of example, as shown in FIG. 7, the terminal displays an information synchronization control 703 on a backpack interface 702 of a first virtual object 701. Thus, when receiving a click/tap operation of a player for the information synchronization control 703, the terminal controls the first virtual object 701 to transmit first virtual item difference information 704 to another virtual object within a virtual camp.

In the foregoing embodiment, by setting the information synchronization control on the backpack interface, the first virtual object having an item exchange requirement may be directly controlled to transmit the first virtual item difference information to another virtual object within the virtual camp, thereby improving efficiency of communication about virtual items between virtual objects within the virtual camp, and improving efficiency of virtual item exchange between the virtual objects.

In some embodiments, considering that a virtual object continuously obtains a virtual item in a virtual environment and an actual possession quantity of the virtual item is usually greater than an upper quantity limit, there is a virtual item discarding requirement. Therefore, the terminal may further additionally set a discard control on the backpack interface. The discard control is configured to trigger the first virtual object to discard an excess first virtual item by one click/tap without separately discarding each first virtual item in sequence.

In a possible implementation, when receiving a trigger operation of a player for a discard control, the terminal first determines a to-be-discarded virtual item of a first virtual object and a discard quantity of the to-be-discarded virtual item. The to-be-discarded virtual item is a virtual item having an actual possession quantity greater than an upper quantity limit among virtual items corresponding to the first virtual object. Further, the terminal controls, according to the discard quantity, the first virtual object to discard the same number of to-be-discarded virtual items as the discard quantity.

In a possible implementation, to enable another virtual object within a virtual camp to know that the first virtual object has discarded a first virtual item, and to pick up the first virtual item in time, the terminal may further control the first virtual object to perform place marking on a to-be-discarded virtual item, so as to control the first virtual object to transmit an object discarding message to at least one other virtual object within the virtual camp. The object discarding message may include at least one of a type of the to-be-discarded virtual item, a discard quantity, and place marking information. The place marking information may be coordinate information.

In some embodiments, to optimize a control layout effect on the backpack interface, the terminal may further set a display condition of the discard control. The terminal displays the discard control on the backpack interface only when the first virtual object has no virtual item lacked and has a virtual item having an actual possession quantity greater than an upper quantity limit.

In a possible implementation, the terminal first obtains an actual possession quantity and an upper quantity limit of a virtual item corresponding to the first virtual object, and compares the actual possession quantity of each virtual item with the upper quantity limit, to display the discard control on the backpack interface in a case that the first virtual object has at least one virtual item having the actual possession quantity greater than the upper quantity limit. In another possible implementation, the discard control is displayed on the backpack interface in a case that the actual possession quantities of all virtual items of the first virtual object are greater than the upper quantity limits.

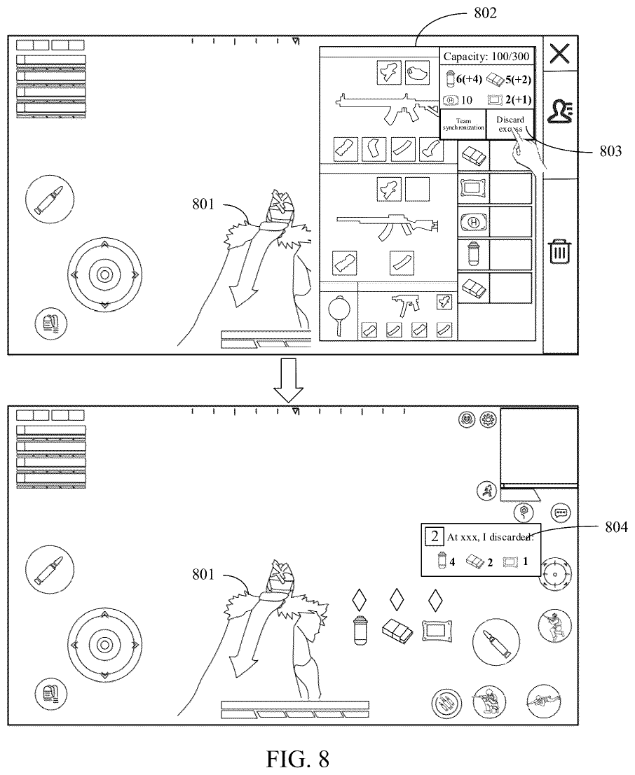

By way of example, as shown in FIG. 8, when no virtual item is lacked from a first virtual object 801, the terminal displays a discard control 803 on a backpack interface 802 of the first virtual object 801, and when receiving a click/tap operation performed by a player for the discard control 803, controls the first virtual object 801 to discard an excess first virtual item, mark the discarded virtual item, and transmit an item discarding message 804 to another virtual object within a virtual camp.

In the foregoing embodiment, by setting the discard control on the backpack interface, the first virtual object is controlled to discard an excess virtual item by one click/tap in a case that an actual possession quantity of at least one virtual item of the first virtual object is greater than an upper quantity limit, thereby improving efficiency of discarding a virtual item by a virtual object, and facilitating management of the virtual item.

In some embodiments, considering that a virtual object in a virtual battle does not always have a virtual item exchange requirement, for example, the first virtual object no longer may perform virtual item exchange after performing virtual item exchange for a single time, or the first virtual object no longer may perform virtual item exchange by picking up a virtual item in a virtual environment after entering an item exchange state, to improve efficiency of controlling a state of the first virtual object, the terminal may further additionally set an application cancel control, to control the first virtual object to exit the item exchange state when receiving a trigger operation of a player for the application cancel control.

In a possible implementation, to optimize a control display effect, the terminal may further directly update the exchange application control to the application cancel control after receiving a trigger operation for the exchange application control. Thus, in a case that the first virtual object is in the item exchange state, the terminal controls the first virtual object to exit the item exchange state in response to the trigger operation for the application cancel control.

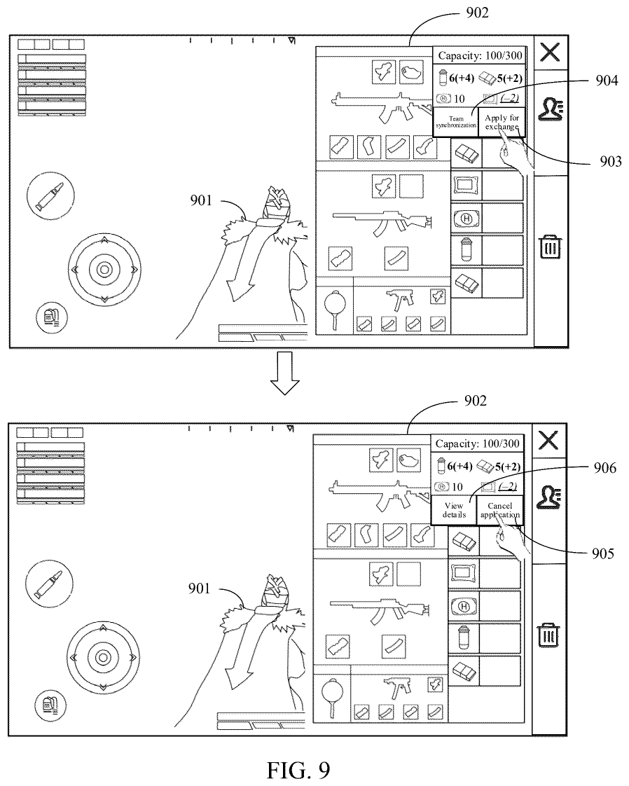

By way of example, as shown in FIG. 9, to optimize a control display effect within a backpack interface 902 of a first virtual object 901, the terminal first displays an exchange application control 903 and an information synchronization control 904 on the backpack interface 902. When receiving a click/tap operation for the exchange application control 903, the terminal controls the first virtual object 901 to enter an item exchange state, updates the exchange application control 903 to an application cancel control 905, and updates the information synchronization control 904 to an exchange details control 906. Thus, when receiving a click/tap operation for the application cancel control 905, the terminal may control the first virtual object 901 to exit the item exchange state.

In the foregoing embodiment, by setting the application cancel control, the first virtual object in the item exchange state may exit the item exchange state at any time, thereby improving efficiency of controlling a virtual object in a virtual battle.

In some embodiments, in a case that the first virtual object is in the item exchange state, to enable the first virtual object to learn and view, in time, virtual item difference information of another virtual object in the item exchange state within the virtual camp, when the another virtual object in the item exchange state within the virtual camp enters a line-of-sight range of the first virtual object, the terminal may present, to the first virtual object, virtual item difference information corresponding to the another virtual object.

In a possible implementation, in a case that a second virtual object falls within the virtual camp on a battle interface and the second virtual object is in the item exchange state, the terminal may obtain an actual possession quantity and an upper quantity limit of a virtual item corresponding to the second virtual object, and determine second virtual item difference information corresponding to the second virtual object according to the actual possession quantities and upper quantity limits of the virtual items, so as to update and display the second virtual item difference information around the second virtual object.

In some embodiments, the virtual item difference information is configured for representing a difference situation between the actual possession quantity and the upper quantity limit of the virtual item corresponding to the second virtual object.

In some embodiments, to facilitate virtual item exchange between virtual objects in the item exchange state, the terminal may further additionally set an item exchange control. The item exchange control may implement quick virtual item exchange between the virtual objects in the item exchange state.

In a possible implementation, in a case that an object distance between the second virtual object in the item exchange state and the first virtual object in the virtual environment is less than a distance threshold, the terminal may display the item exchange control on the battle interface, to control the first virtual object and the second virtual object to perform virtual item exchange in response to a trigger operation of the player for the item exchange control.

In some embodiments, considering that object distances between a plurality of second virtual objects in the item exchange state and the first virtual object may be less than the distance threshold, to improve efficiency of virtual item exchange between a plurality of virtual objects, the terminal may further control the first virtual object to simultaneously perform virtual item exchange with the plurality of second virtual objects when receiving a trigger operation for the item exchange control.

In a possible implementation, in a case that the object distance between the first virtual object and at least one second virtual object is less than the distance threshold, the terminal may display the item exchange control. When receiving a trigger operation of the player for the item exchange control, the player further may determine a second target virtual object having an object distance to the first virtual object less than the distance threshold, to control the first virtual object to perform virtual item exchange with the second target virtual object according to first virtual item difference information of the first virtual object and second virtual item difference information of the second target virtual object. The second target virtual object is any or selected one of the plurality of second virtual objects, or a virtual object closest to the first virtual object.

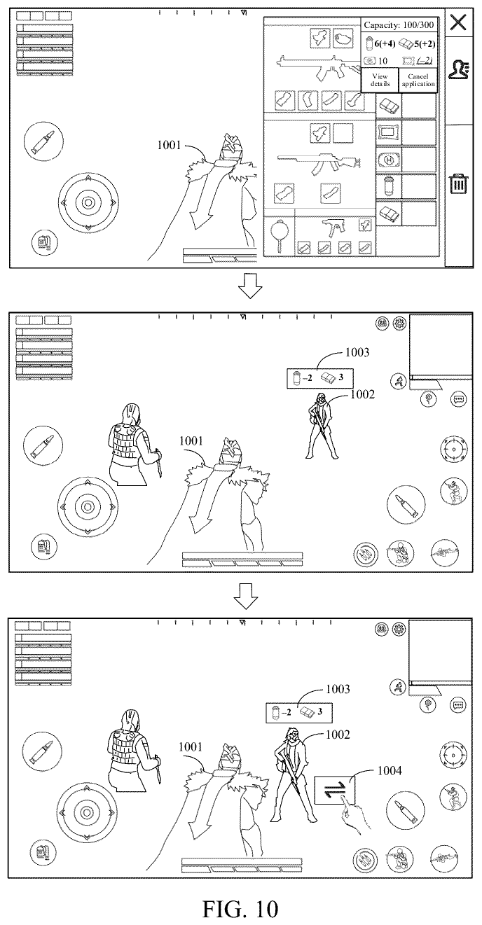

By way of example, as shown in FIG. 10, after a first virtual object 1001 is controlled to enter an item exchange state, and in the presence of a second virtual object 1002 also in the item exchange state within a virtual camp in a line-of-sight range of the first virtual object 1001, the terminal displays second virtual item difference information 1003 corresponding to the second virtual object 1002 on the top of the head of the second virtual object 1002. In a case that an object distance between the first virtual object 1001 and the second virtual object 1002 is less than a distance threshold, an item exchange control 1004 is displayed. Thus, the terminal controls the first virtual object 1001 and the second virtual object 1002 to perform virtual item exchange when receiving a click/tap operation of a player for the item exchange control 1004.

In the foregoing embodiment, in a case that a second virtual object also in the item exchange state falls within the virtual camp and the second virtual object is within the line-of-sight range of the first virtual object, second virtual item difference information corresponding to the second virtual object is displayed around the second virtual object on a battle interface, so that the player can quickly learn a current virtual item difference situation of the second virtual object, thereby improving efficiency of communication between virtual objects about a virtual item. In addition, the item exchange control is displayed in a case that the object distance between the first virtual object and the second virtual object is less than the distance threshold, and after a trigger operation for the item exchange control is received, the first virtual object and the second virtual object may be directly controlled to perform virtual item exchange, thereby improving efficiency of virtual item exchange between virtual objects in an item exchange state.

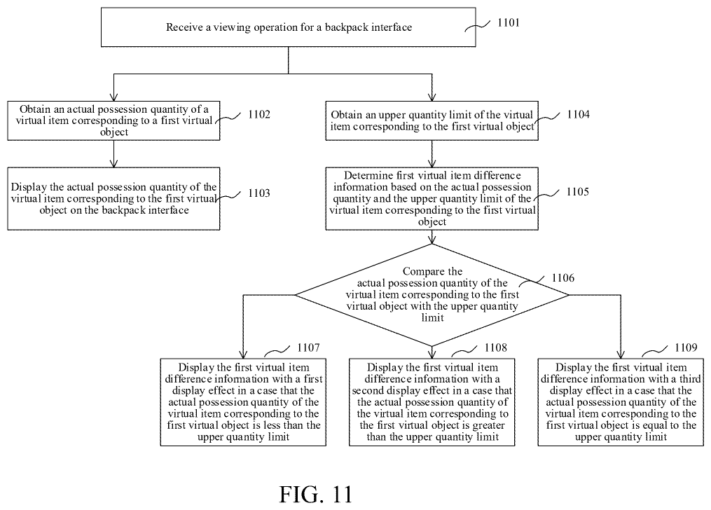

FIG. 11 shows a flowchart of displaying first virtual item difference information according to some embodiments. A terminal displays first virtual item difference information according to the following operations.

Operation 1101: Receive a viewing operation for a backpack interface.

Operation 1102: Obtain an actual possession quantity of a virtual item corresponding to a first virtual object.

When receiving a viewing operation of a player for the backpack interface, the terminal may obtain actual possession quantities of virtual items corresponding to the first virtual object.

Operation 1103: Display the actual possession quantity of the virtual item corresponding to the first virtual object on the backpack interface.

To make the player learn an actual possession quantity of a virtual item currently possessed by the first virtual object, the terminal displays the actual possession quantity of the virtual item corresponding to the first virtual object on the backpack interface. For example, the terminal displays actual possession quantities of virtual items corresponding to the first virtual object on the backpack interface in a white font.

Operation 1104: Obtain an upper quantity limit of the virtual item corresponding to the first virtual object.

To determine a quantity difference between the virtual items of the first virtual object, the terminal further may obtain upper quantity limits of the virtual items corresponding to the first virtual object.

Operation 1105: Determine first virtual item difference information based on the actual possession quantity and the upper quantity limit of the virtual item corresponding to the first virtual object.

After obtaining actual possession quantities and upper quantity limits of the virtual items corresponding to the first virtual object, the terminal may calculate first virtual item difference information corresponding to the virtual items by subtracting the upper quantity limit from the actual possession quantity.

Operation 1106: Compare the actual possession quantity of the virtual item corresponding to the first virtual object with the upper quantity limit.

To distinguish between different difference cases, the terminal may display the first virtual item difference information with different display effects. Therefore, the terminal may compare the actual possession quantity of the virtual item corresponding to the first virtual object with the upper quantity limit.

Operation 1107: Display the first virtual item difference information with a first display effect in a case that the actual possession quantity of the virtual item corresponding to the first virtual object is less than the upper quantity limit.

The terminal may display the first virtual item difference information with a first display effect, for example, display “(−4)” in a red font, in a case that the actual possession quantity of the virtual item corresponding to the first virtual object is less than a first upper quantity limit.

Operation 1108: Display the first virtual item difference information with a second display effect in a case that the actual possession quantity of the virtual item corresponding to the first virtual object is greater than the upper quantity limit.

The terminal may display the first virtual item difference information with a second display effect, for example, display “(+2)” in a green font, in a case that the actual possession quantity of the virtual item corresponding to the first virtual object is greater than the upper quantity limit.

Operation 1109: Display the first virtual item difference information with a third display effect in a case that the actual possession quantity of the virtual item corresponding to the first virtual object is equal to the upper quantity limit.

The terminal may display the first virtual item difference information with a third display effect in a case that the actual possession quantity of the virtual item corresponding to the first virtual object is equal to the upper quantity limit. For example, the terminal displays only the actual possession quantity and does not display a quantity difference.

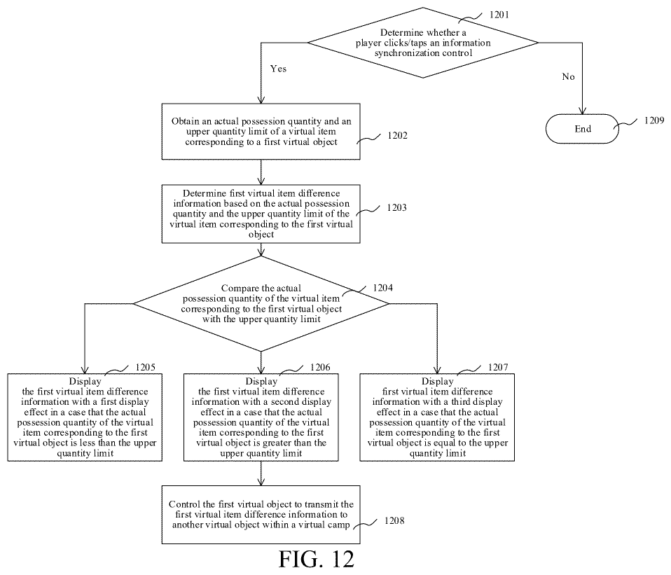

FIG. 12 shows a flowchart of synchronizing first virtual item difference information according to some embodiments. A terminal synchronizes first virtual item difference information according to the following operations.

Operation 1201: Determine whether a player clicks/taps an information synchronization control.

When receiving a trigger operation of the player for the information synchronization control, operation 1202 is performed. Otherwise, operation 1209 is performed.

Operation 1202: Obtain an actual possession quantity and an upper quantity limit of a virtual item corresponding to a first virtual object.

When receiving a trigger operation of the player for the information synchronization control, the terminal obtains the actual possession quantity and the upper quantity limit of the virtual item corresponding to the first virtual object.

Operation 1203: Determine first virtual item difference information based on the actual possession quantity and the upper quantity limit of the virtual item corresponding to the first virtual object.

After obtaining the actual possession quantity and the upper quantity limit of the virtual item corresponding to the first virtual object, the terminal may determine the first virtual item difference information by calculating a difference.

Operation 1204: Compare the actual possession quantity of the virtual item corresponding to the first virtual object with the upper quantity limit.

To distinguish between different difference cases, the terminal may transmit the first virtual item difference information with different display effects. Therefore, the terminal may compare the actual possession quantity of the virtual item corresponding to the first virtual object with the upper quantity limit.

Operation 1205: Display the first virtual item difference information with a first display effect in a case that the actual possession quantity of the virtual item corresponding to the first virtual object is less than the upper quantity limit.

The terminal may display the first virtual item difference information with a first display effect, for example, display “(−4)” in a red font, in a case that the actual possession quantity of the virtual item corresponding to the first virtual object is less than the upper quantity limit.

Operation 1206: Display the first virtual item difference information with a second display effect in a case that the actual possession quantity of the virtual item corresponding to the first virtual object is greater than the upper quantity limit.

The terminal may display the first virtual item difference information with a second display effect, for example, display “(+2)” in a green font, in a case that the actual possession quantity of the virtual item corresponding to the first virtual object is greater than the upper quantity limit.

Operation 1207: Display the first virtual item difference information with a third display effect in a case that the actual possession quantity of the virtual item corresponding to the first virtual object is equal to the upper quantity limit.

The terminal may display the first virtual item difference information with a third display effect in a case that the actual possession quantity of the virtual item corresponding to the first virtual object is equal to the upper quantity limit. For example, the terminal displays only the actual possession quantity and does not display a quantity difference.

Operation 1208: Control the first virtual object to transmit the first virtual item difference information to another virtual object within a virtual camp.

After determining the first virtual item difference information, the terminal may control the first virtual object to transmit the first virtual item difference information to another virtual object within the virtual camp.

Operation 1209: End the procedure.

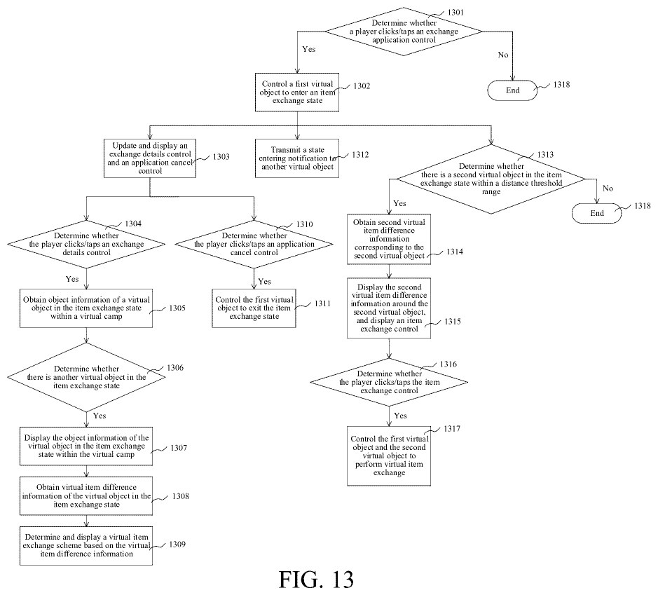

FIG. 13 shows a flowchart of virtual item exchange within a virtual camp according to some embodiments. A terminal performs virtual item exchange within a virtual camp according to the following operations.

Operation 1301: Determine whether a player clicks/taps an exchange application control.

When receiving a trigger operation of a player for an exchange application control, operation 1302 is performed. Otherwise, operation 1318 is performed.

Operation 1302: Control a first virtual object to enter an item exchange state.

When receiving the trigger operation of the player for the exchange application control, the terminal controls a first virtual object to enter an item exchange state.

Operation 1303: Update and display an exchange details control and an application cancel control.

To reduce an interface region occupied by control display, the terminal may update an information synchronization control to an exchange details control, and update the exchange application control to an application cancel control.

Operation 1304: Determine whether the player clicks/taps the exchange details control.

When receiving a trigger operation of the player for the exchange details control, operation 1305 is performed.

Operation 1305: Obtain object information of a virtual object in the item exchange state within a virtual camp.

When receiving the trigger operation of the player for the exchange details control, the terminal obtains object information of a virtual object in the item exchange state within a virtual camp. The object information may include an object number, an identifier, an avatar, position information, and the like.

Operation 1306: Determine whether there is another virtual object in the item exchange state.

If there is another virtual object in the item exchange state, operation 1307 is performed.

Operation 1307: Display the object information of the virtual object in the item exchange state within the virtual camp.

The object information of the virtual object in the item exchange state within the virtual camp is displayed in an exchange details information display region of a backpack interface.

Operation 1308: Obtain virtual item difference information of the virtual object in the item exchange state.

The terminal obtains virtual item difference information corresponding to virtual objects in the item exchange state within the virtual camp.

Operation 1309: Determine and display a virtual item exchange scheme based on the virtual item difference information.

The terminal determines, according to the virtual item difference information corresponding to the virtual objects in the item exchange state, virtual item exchange schemes applicable to the virtual objects in the item exchange state, and displays a first virtual item exchange scheme corresponding to the first virtual object on the backpack interface. The first virtual item exchange scheme includes object information corresponding to another virtual object in the item exchange state, and a predicted virtual item quantity change result for the first virtual object when the virtual objects in the item exchange state perform virtual item exchange indicated by the virtual item exchange schemes.

Detailed determining operations of the virtual item exchange schemes include the following operations (1) to (7):
1) Collect statistics on virtual objects in an item exchange state within a virtual camp.
2) Collect statistics on types and exchange quantities of to-be-exchanged virtual items for the foregoing virtual objects.
3) Summarize types and exchange quantities of all to-be-exchanged virtual items.
4) Read a difference between an actual possession quantity and an upper quantity limit of each to-be-exchanged virtual item for the foregoing virtual objects.
5) Determine whether excess to-be-exchanged virtual items of each virtual object are lacked by other virtual objects, and determine a lack quantity of the other virtual objects and an actual possession quantity of the to-be-exchanged virtual items for the other virtual objects.
6) Determine a virtual item exchange scheme applicable to the foregoing virtual object. For an excess to-be-exchanged virtual item of a virtual object, another virtual object lacks the to-be-exchanged virtual item. If there is another virtual object, the excess to-be-exchanged virtual item is allocated to the another virtual object, and a virtual item allocation quantity is a lack quantity of the to-be-exchanged virtual item for the another virtual object. If there are a plurality of other virtual objects, the excess to-be-exchanged virtual item is preferentially allocated to another virtual object having a smaller actual possession quantity of the to-be-exchanged virtual item, and a virtual item allocation quantity is a lack quantity of the to-be-exchanged virtual item for the another virtual object. If actual possession quantities of the to-be-exchanged virtual item for a plurality of other virtual objects, the excess to-be-exchanged virtual item is preferentially allocated to another virtual object having a larger difference between an actual possession quantity and upper quantity limit, and a virtual item allocation quantity is a lack quantity of the to-be-exchanged virtual item for the another virtual object. If a plurality of other virtual objects correspond to the same difference, the excess to-be-exchanged virtual item is arbitrarily allocated to any other virtual object, and a virtual item allocation quantity is a lack quantity of the to-be-exchanged virtual item for the another virtual object.
7) Determine whether there is still an excess to-be-exchanged virtual item waiting for virtual item exchange, if there is still an excess to-be-exchanged virtual item, determine actual possession quantities of the to-be-exchanged virtual item for all virtual objects, preferentially allocate to-be-exchanged virtual item to another virtual object having a smaller actual possession quantity, and if actual possession quantities for a plurality of other virtual objects are the same, arbitrarily allocate the to-be-exchanged virtual item to any other virtual object.

In an example, virtual objects in an item exchange state within a virtual camp include a first virtual object, a second virtual object, and a third virtual object. The first virtual object has an excess of 2 medical kits and 3 bandages. The second virtual object has an excess of 1 painkiller and 2 adrenaline shots. The third virtual character has no excess medicines. Thus, the terminal may determine that to-be-exchanged virtual items of the first virtual object are 2 medical kits and 3 bandages, and to-be-exchanged virtual items of the second virtual object are 1 painkiller and 2 adrenaline shots. The total to-be-exchanged virtual items are summarized as 2 medical kits, 3 bandages, 1 painkiller, and 2 adrenaline shots.

Further, the terminal determines virtual item difference information of the virtual objects. The first virtual object has an excess of 2 medical kits and 3 bandages but lacks 5 painkillers and 1 adrenaline shot. The second virtual object has an excess of 1 painkiller and 2 adrenaline shots. The third virtual object lacks 1 medical kit and 2 painkillers. Thus, it is determined that only the third virtual object lacks the excess 2 medical kits of the first virtual object and the third virtual object needs 1 medical kit. Both the first virtual object and the third virtual object lack the excess 1 painkiller of the second virtual object, the first virtual object needs 5 painkillers, and the third virtual object needs 2 painkillers. Only the first virtual object lacks the excess 2 adrenaline shots of the second virtual object, and the first virtual object needs 1 adrenaline shot. Therefore, the terminal may directly allocate the excess 1 medical kit of the first virtual object to the third virtual object, and allocate the excess 1 adrenaline shot of the second virtual object to the first virtual object.

For the painkillers needed by the first virtual object and the third virtual object, the terminal may first compare the quantities of painkillers currently possessed by the first virtual object and the third virtual object. In a case that the first virtual object has no painkiller and the third virtual object has 1 painkiller, the painkiller may be preferentially allocated to the first virtual object. In a case that both the first virtual object and the third virtual object have 1 painkiller, because the first virtual object lacks 5 painkillers and the third virtual object lacks 2 painkillers, the first virtual object lacks a relatively large quantity of painkillers, and the painkiller may be preferentially allocated to the first virtual object. For the excess to-be-exchanged virtual items, the terminal may arbitrarily allocate the excess to-be-exchanged virtual items to the virtual objects.

Operation 1310: Determine whether the player clicks/taps the application cancel control.

When receiving a trigger operation of the player for the application cancel control, operation 1311 is performed.

Operation 1311: Control the first virtual object to exit the item exchange state.

When receiving the trigger operation of the player for the application cancel control, the terminal controls the first virtual object to exit the item exchange state.

Operation 1312: Transmit a state entering notification to another virtual object.

When receiving the trigger operation of the player for the exchange application control, the terminal controls the first virtual object to enter the item exchange state, and transmits a state entering notification to another virtual object.

Operation 1313: Determine whether there is a second virtual object in the item exchange state within a distance threshold range.

The terminal determines whether there is a second virtual object in the item exchange state in a virtual environment, where an object distance between the second virtual object and the first virtual object is within a distance threshold range. In a case that there is the second virtual object in the item exchange state, operation 1314 is performed.

Operation 1314: Obtain second virtual item difference information corresponding to the second virtual object.

To enable another virtual object in the item exchange state to learn a current virtual item possession situation of the virtual object, the terminal obtains second virtual item difference information corresponding to the second virtual object.

Operation 1315: Display the second virtual item difference information around the second virtual object, and display an item exchange control.

Further, the terminal displays the second virtual item difference information around the second virtual object, and displays an item exchange control.

Operation 1316: Determine whether the player clicks/taps the item exchange control.

When receiving a trigger operation of the player for the item exchange control, operation 1317 is performed.

Operation 1317: Control the first virtual object and the second virtual object to perform virtual item exchange.

When receiving the trigger operation of the player for the item exchange control, the terminal controls the first virtual object and the second virtual object to perform virtual item exchange.

Operation 1318: End the procedure.

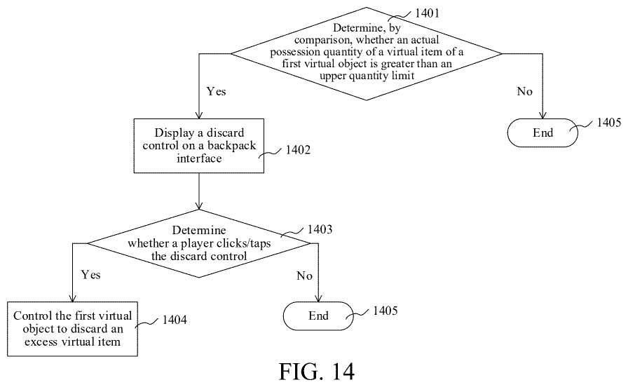

FIG. 14 shows a flowchart of discarding an excess virtual item according to some embodiments. A terminal discards an excess virtual item according to the following operations.

Operation 1401: Determine, by comparison, whether an actual possession quantity of a virtual item of a first virtual object is greater than an upper quantity limit.

To reduce an interface region occupied by control display, the terminal may first compare an actual possession quantity of a virtual item of a first virtual object with an upper quantity limit.

Operation 1402: Display a discard control on a backpack interface.

In a case that the actual possession quantity of the virtual item of the first virtual object is greater than the upper quantity limit, the terminal displays a discard control on a backpack interface.

Operation 1403: Determine whether a player clicks/taps the discard control.

When receiving a trigger operation of the player for the discard control, operation 1404 is performed.

Operation 1404: Control the first virtual object to discard an excess virtual item.

When receiving the trigger operation of the player for the discard control, the terminal controls the first virtual object to discard an excess virtual item.

Operation 1405: End the procedure.

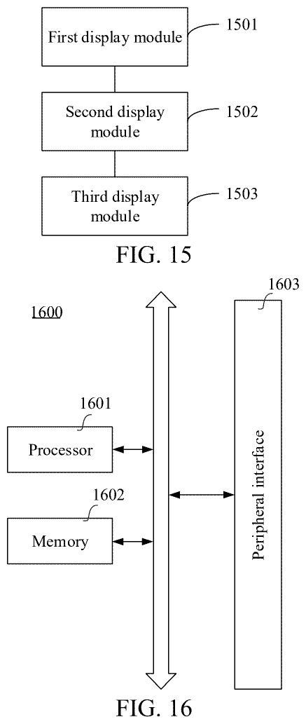

FIG. 15 shows a structural block diagram of an apparatus for presenting virtual item exchange schemes according to some embodiments. The apparatus includes at least part of a first display module 1501, a second display module 1502, and a third display module 1503.

The first display module 1501 is configured to display an exchange application control on a backpack interface of a first virtual object, the exchange application control being configured to trigger the first virtual object to initiate a virtual item exchange application within a virtual camp.

The second display module 1502 is configured to control the first virtual object to enter an item exchange state in response to a trigger operation for the exchange application control.

The third display module 1503 is configured to present a first virtual item exchange scheme on the backpack interface, the first virtual item exchange scheme being configured for indicating a predicted virtual item quantity change result for the first virtual object resulted from virtual item exchange.

In some embodiments, the second display module 1502 is further configured to display an exchange details control on the backpack interface, the exchange details control being configured to view the first virtual item exchange scheme. The third display module 1503 is further configured to present the first virtual item exchange scheme on the backpack interface in response to a trigger operation for the exchange details control.

In some embodiments, the third display module 1503 includes:
a first obtaining unit, configured to obtain virtual item difference information corresponding to virtual objects currently in the item exchange state within the virtual camp in response to a trigger operation for the exchange details control, the virtual item difference information being configured for representing a difference situation between an actual possession quantity and an upper quantity limit of a virtual item corresponding to a virtual object;
a first determining unit, configured to determine virtual item exchange schemes applicable to the virtual objects in the item exchange state based on the virtual item difference information corresponding to the virtual objects in the item exchange state; and
a first display unit, configured to present the first virtual item exchange scheme on the backpack interface, the first virtual item exchange scheme including object information corresponding to another virtual object in the item exchange state, and the predicted virtual item quantity change result for the first virtual object when the virtual objects in the item exchange state perform virtual item exchange indicated by the virtual item exchange schemes.

In some embodiments, the first determining unit is configured to:
collect statistics on a type and an exchange quantity of a to-be-exchanged virtual item within the virtual camp based on the virtual item difference information corresponding to the virtual objects in the item exchange state, the to-be-exchanged virtual item being a virtual item having an actual possession quantity greater than an upper quantity limit among the virtual items corresponding to the virtual objects in the item exchange state;
determine a virtual item allocation quantity of the to-be-exchanged virtual item between the virtual objects in the item exchange state; and
generate the virtual item exchange schemes applicable to the virtual objects in the item exchange state.

In some embodiments, in the presence of at least two virtual objects in the item exchange state within the virtual camp, the first determining unit is configured to:
determine a lack situation and a possession situation of the to-be-exchanged virtual item for the virtual objects in the item exchange state based on the type of the to-be-exchanged virtual item; and
determine a virtual item allocation quantity of the to-be-exchanged virtual item between the virtual objects in the item exchange state based on the exchange quantity of the to-be-exchanged virtual item and the lack situation and the possession situation of the to-be-exchanged virtual item for the virtual objects in the item exchange state.

In some embodiments, the first determining unit is further configured to:
preferentially determine a target virtual item allocation quantity of the to-be-exchanged virtual item corresponding to a first target virtual object in a case that an actual possession quantity of the to-be-exchanged virtual item for the first target virtual object is less than an actual possession quantity of the to-be-exchanged virtual item for another virtual object; and
preferentially determine a target virtual item allocation quantity of the to-be-exchanged virtual item corresponding to the first target virtual object in a case that the actual possession quantity of the to-be-exchanged virtual item for the first target virtual object is equal to the actual possession quantity of the to-be-exchanged virtual item for the another virtual object and in a case that a lack quantity of the to-be-exchanged virtual item for the first target virtual object is greater than a lack quantity of the to-be-exchanged virtual item for the another virtual object.

In some embodiments, in the presence of at least two virtual objects in the item exchange state other than the first virtual object within the virtual camp, the apparatus further includes:
a fourth display module, configured to present a target virtual item exchange scheme on the backpack interface in response to a trigger operation for target object information, the target virtual item exchange scheme being configured for indicating a predicted virtual item quantity change result resulted from virtual item exchange between the first virtual object and a virtual object corresponding to the target object information.

In some embodiments, the apparatus further includes:
a first obtaining module, configured to obtain position information of the virtual objects in the item exchange state in a virtual environment;
a first determining module, configured to determine a target moving place based on the position information and attribute values of the virtual objects in the item exchange state;
a fifth display module, configured to display a place control on the backpack interface, the place control being configured to trigger the first virtual object to initiate place assembling within the virtual camp; and
a sixth display module, configured to display place information of the target moving place on a virtual map in response to a trigger operation for the place control, the place information being configured for instructing at least one other virtual object in the item exchange state to move toward the target moving place to perform virtual item exchange.

In some embodiments, the first display module 1501 is configured to:
obtain an actual possession quantity and an upper quantity limit of a virtual item corresponding to the first virtual object in response to a viewing operation for the backpack interface;
determine first virtual item difference information of the virtual items corresponding to the first virtual object based on the actual possession quantity and the upper quantity limit of the virtual item corresponding to the first virtual object, the first virtual item difference information being configured for representing a difference situation between the actual possession quantity and the upper quantity limit of the virtual item corresponding to the first virtual object;
display the first virtual item difference information on the backpack interface; and
display the exchange application control on the backpack interface in a case that the actual possession quantity of at least one virtual item for the first virtual object is less than the upper quantity limit.

In some embodiments, the first display module 1501 is further configured to:
display the first virtual item difference information on the backpack interface with a first display effect in a case that the actual possession quantity of the virtual item corresponding to the first virtual object is less than the upper quantity limit;
display the first virtual item difference information on the backpack interface with a second display effect in a case that the actual possession quantity of the virtual item corresponding to the first virtual object is greater than the upper quantity limit; and
display the first virtual item difference information on the backpack interface with a third display effect in a case that the actual possession quantity of the virtual item corresponding to the first virtual object is equal to the upper quantity limit.

In some embodiments, the backpack interface further includes an information synchronization control, the information synchronization control being configured to synchronize first virtual item difference information of the first virtual object to another virtual object within the virtual camp, and the first virtual item difference information being configured for representing a difference situation between the actual possession quantity and the upper quantity limit of the virtual item corresponding to the first virtual object.

The apparatus further includes:
a first control module, configured to control the first virtual object to transmit the first virtual item difference information to the another virtual object within the virtual camp in response to a trigger operation for the information synchronization control.

In some embodiments, the backpack interface further includes a discard control, the discard control being configured to trigger the first virtual object to discard an excess virtual item.

The apparatus further includes:
a second determining module, configured to determine a to-be-discarded virtual item of the first virtual object and a discard quantity of the to-be-discarded virtual item in response to a trigger operation for the discard control, the to-be-discarded virtual item being a virtual item having an actual possession quantity greater than an upper quantity limit among the virtual items corresponding to the first virtual object;
a second control module, configured to control the first virtual object to discard the to-be-discarded virtual item based on the discard quantity, and perform place marking on the to-be-discarded virtual item; and
a third control module, configured to control the first virtual object to transmit an item discarding message to at least one other virtual object within the virtual camp, the item discarding message including at least one of types, a discard quantity, and place marking information of the to-be-discarded virtual item.

In some embodiments, the apparatus further includes:
a second obtaining module, configured to obtain an actual possession quantity and an upper quantity limit of a virtual item corresponding to the first virtual object; and
a seventh display module, configured to display the discard control on the backpack interface in a case that the actual possession quantity of at least one virtual item corresponding to the first virtual object is greater than the upper quantity limit.

In some embodiments, the second display module 1502 is further configured to:
update the exchange application control to an application cancel control in response to a trigger operation for the exchange application control.

The apparatus further includes:
a fourth control module, configured to control the first virtual object to exit the item exchange state in response to a trigger operation for the application cancel control.

In some embodiments, the apparatus further includes:
a third obtaining module, configured to obtain, in a case that a second virtual object falls within the virtual camp on a battle interface and the second virtual object is in the item exchange state, an actual possession quantity and an upper quantity limit of a virtual item corresponding to the second virtual object; and
an eighth display module, configured to update and display second virtual item difference information of the virtual item corresponding to the second virtual object around the second virtual object based on the actual possession quantity and the upper quantity limit of the virtual item corresponding to the second virtual object, the second virtual item difference information being configured for representing a difference situation between the actual possession quantity and the upper quantity limit of the virtual item corresponding to the second virtual object.

In some embodiments, the apparatus further includes:
a ninth display module, configured to display an item exchange control in a case that an object distance between the first virtual object and at least one second virtual object is less than a distance threshold;
a third determining module, configured to determine a second target virtual object in response to a trigger operation for the item exchange control, an object distance between the second target virtual object and the first virtual object being less than the distance threshold; and
a fifth control module, configured to control the first virtual object to perform virtual item exchange with the second target virtual object based on first virtual item difference information of the first virtual object and second virtual item difference information of the second target virtual object.

In conclusion, in some embodiments, an exchange application control is additionally displayed on a backpack interface of a first virtual object. Thus, in a case that a trigger operation for the exchange application control is received, the first virtual object may be controlled to enter an item exchange state, and an exchange details control is displayed on the backpack interface. By receiving a trigger operation for the exchange details control, a first virtual item exchange scheme may be presented on the backpack interface. Thus, the first virtual object may learn, without text or voice communication, object information of another virtual object that has a virtual item exchange requirement in a current virtual camp, and a predicted virtual item quantity change result resulted from item exchange, to omit a virtual item communication process between virtual objects, thereby improving efficiency of virtual item exchange between virtual objects within a virtual camp.

The apparatus provided in the foregoing embodiment is illustrated only with an example of division of the foregoing function modules. In practical applications, the foregoing functions may be allocated to and completed by different function modules according to requirements. The internal structure of the apparatus is divided into different function modules to complete all or some of the functions described above. In addition, the apparatus and method embodiments provided in the foregoing embodiments belong to the same conception. For an implementation process, refer to the method embodiments. Details are not described herein again.

FIG. 16 shows a structural block diagram of a terminal 1600 according to some embodiments. The terminal 1600 may be a portable mobile terminal, for example, a smartphone, a tablet computer, an MP3 player, or an MP4 player. The terminal 1600 may be further referred to as other names such as user equipment and a portable terminal.

Generally, the terminal 1600 includes a processor 1601 and a memory 1602. The processor 1601 may include one or more processing cores, for example, a 4-core processor or an 8-core processor. The processor 1601 may be implemented by using at least one hardware form of a digital signal processing (DSP), a field-programmable gate array (FPGA), and a programmable logic array (PLA). The processor 1601 may further include a main processor and a coprocessor. The main processor is a processor for processing data in an awake state, and is alternatively referred to as a central processing unit (CPU). The coprocessor is a low-power processor for processing the data in a standby state. In some embodiments, the processor 1601 may be integrated with a graphics processing unit (GPU). The GPU is configured to render and draw content that may be displayed on a display screen. In some embodiments, the processor 1601 may further include an artificial intelligence (AI) processor. The AI processor is configured to process computing operations correlated with machine learning. The memory 1602 may include one or more computer-readable storage media. The computer-readable storage medium may be tangible and non-transient. The memory 1602 may further include a high-speed random access memory, as well as a non-volatile memory, such as one or more disk storage devices and flash storage devices. In some embodiments, a non-transient computer-readable storage medium in the memory 1602 is configured to store at least one instruction. The at least one instruction is executed by the processor 1601 to implement the method for presenting virtual item exchange schemes provided in some embodiments.

In some embodiments, the terminal 1600 may alternatively include: a peripheral interface 1603 and at least one peripheral. The peripheral interface 1603 may be configured to connect at least one peripheral related to input/output (I/O) to the processor 1601 and the memory 1602. The processor 1601, the memory 1602 and the peripheral interface 1603 are integrated on a same chip or circuit board. In some other embodiments, any one or two of the processor 1601, the memory 1602, and the peripheral interface 1603 may be implemented on a single chip or circuit board. This is not limited in some embodiments.

A person skilled in the art may understand that the structure shown in FIG. 16 constitutes no limitation on the terminal 1600, and the terminal may include more or fewer assemblies than those shown in the figure, or some assemblies may be combined, or a different assembly deployment may be used.

Some embodiments further provides a computer-readable storage medium. The computer-readable storage medium has at least one program stored therein. The at least one program is loaded and executed by a processor to implement the method for presenting virtual item exchange schemes in the foregoing embodiments.

Some embodiments provides a computer program product. The computer program product includes computer instructions. The computer instructions are stored in a computer-readable storage medium. A processor of a terminal reads the computer instructions from the computer-readable storage medium. The processor executes the computer instructions, to cause the terminal to perform the method for presenting virtual item exchange schemes in exemplary implementations of the foregoing aspect.

A person skilled in the art may be aware that in the foregoing one or more examples, functions described in embodiments of this application may be implemented by using hardware, software, firmware, or any combination thereof. When being implemented by using software, the functions can be stored in a computer-readable storage medium or may be used as one or more instructions or codes in the computer-readable storage medium for transmission. The computer-readable storage medium includes a computer storage medium and a communications medium, where the communications medium includes any medium that enables a computer program to be transmitted from one place to another. The storage medium may be any available medium accessible to a general-purpose or special-purpose computer. The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A method for presenting virtual item exchange schemes, performed by a computer device, and the method comprising:
displaying, on a user interface of a first virtual object, an exchange request control configured to initiate a virtual item exchange request within a virtual camp;
controlling the first virtual object to enter an item exchange state based on a trigger operation for the exchange request control; and
presenting, on the user interface, a first virtual item exchange scheme configured to indicate a predicted virtual item quantity change for the first virtual object resulting from exchange of virtual items within the virtual camp.

2. The method according to claim 1, wherein the presenting comprises:
displaying, on the user interface, an exchange details control configured to view the first virtual item exchange scheme; and
presenting the first virtual item exchange scheme on the user interface based on a trigger operation for the exchange details control.

3. The method according to claim 1, wherein the presenting comprises:
obtaining difference information corresponding to virtual objects in the item exchange state within the virtual map, the difference information including a difference between an actual possession quantity and an upper quantity limit of one or more virtual item types;
determining virtual item exchange schemes for the virtual objects in the item exchange state based on the difference information; and
presenting the first virtual item exchange scheme on the user interface, wherein the first virtual item exchange scheme includes object information of another virtual object in the item exchange state, and the predicted virtual item quantity change for the first virtual object.

4. The method according to claim 3, wherein the determining comprises:
identifying a to-be-exchanged virtual item within the virtual camp based on the difference information, the to-be-exchanged virtual item being a virtual item having an actual possession quantity greater than an upper quantity limit for at least one virtual object in the item exchange state;
determining a virtual item allocation quantity of the to-be-exchanged virtual item among the virtual objects in the item exchange state; and
generating the virtual item exchange schemes for the virtual objects in the item exchange state.

5. The method according to claim 4, wherein based on at least two virtual objects being in the item exchange state within the virtual camp, the determining the allocation quantity comprises:
determining a lack quantity and a possession quantity of the to-be-exchanged virtual item for the virtual objects in the item exchange state based on the type of the to-be-exchanged virtual item; and
determining the virtual item allocation quantity of the to-be-exchanged virtual item between the virtual objects in the item exchange state based on an exchange quantity of the to-be-exchanged virtual item, the lack quantity for each virtual object, and the possession quantity for each virtual object.

6. The method according to claim 4, wherein the determining a virtual item allocation quantity comprises:
prioritizing allocation to a first target virtual object having a lower possession quantity of the to-be-exchanged virtual item than other virtual objects lacking the same to-be-exchanged virtual item; and
in a case that the first target virtual object and at least one other virtual object have equal current possession quantities of the to-be-exchanged virtual item, prioritizing allocation to whichever virtual object has a greater lack quantity of the to-be-exchanged virtual item.

7. The method according to claim 3, wherein based on at least two other virtual objects being in the item exchange state within the virtual camp, the method further comprises:
receiving a selection of target object information from the object information included in the first virtual item exchange scheme; and
presenting, on the user interface, a target virtual item exchange scheme configured to indicate a predicted virtual item quantity change for the first virtual object resulting from virtual item exchange between only the first virtual object and a virtual object corresponding to the selected target object information.

8. The method according to claim 1, further comprising:
obtaining position information of the virtual objects in the item exchange state in a virtual environment;
determining a target meeting location based on the position information and attribute values of the virtual objects in the item exchange state;
displaying, on the user interface, a place control configured to initiate coordination of movement to the target meeting location within the virtual camp; and
displaying location information of the target meeting location on a virtual map based on a trigger operation for the place control, wherein the location information guides the virtual objects in the item exchange state to converge at the target meeting location for performing virtual item exchange.

9. The method according to claim 1, wherein the displaying comprises:
obtaining an actual possession quantity and an upper quantity limit of a virtual item corresponding to the first virtual object based on a viewing operation for the user interface;
determining difference information for the first virtual object based on comparing the actual possession quantity to the upper quantity limit for each virtual item type;
displaying the difference information on the user interface; and
displaying the exchange request control on the user interface in a case that the actual possession quantity of at least one virtual item type is less than the corresponding upper quantity limit.

10. The method according to claim 9, wherein the displaying the difference information comprises at least one of the following:
displaying the difference information with a first visual indicator in a case that the actual possession quantity of a virtual item type is less than the corresponding upper quantity limit;
displaying the difference information with a second visual indicator in a case that the actual possession quantity of a virtual item type exceeds the corresponding upper quantity limit; or
displaying the difference information with a third visual indicator in a case that the actual possession quantity of a virtual item type equals the corresponding upper quantity limit,
wherein the first, second, and third visual indicators are visually distinct.

11. An apparatus for presenting virtual item exchange schemes, comprising:
at least one memory configured to store program code; and
at least one processor configured to read the program code and operate as instructed by the program code, the program code comprising:
display code configured to cause at least one of the at least one processor to display, on a user interface of a first virtual object, an exchange request control configured to initiate a virtual item exchange request within a virtual camp;
control code configured to cause at least one of the at least one processor to control the first virtual object to enter an item exchange state based on a trigger operation for the exchange request control; and
presentation code configured to cause at least one of the at least one processor to present, on the user interface, a first virtual item exchange scheme configured to indicate a predicted virtual item quantity change for the first virtual object resulting from exchange of virtual items within the virtual camp.

12. The apparatus according to claim 11, wherein the presentation code is further configured to cause at least one of the at least one processor to:
display, on the user interface, an exchange details control configured to view the first virtual item exchange scheme; and
present the first virtual item exchange scheme on the user interface based on a trigger operation for the exchange details control.

13. The apparatus according to claim 11, wherein the presentation code is further configured to cause at least one of the at least one processor to:
obtain difference information corresponding to virtual objects in the item exchange state within the virtual map, the difference information including a difference between an actual possession quantity and an upper quantity limit of one or more virtual item types;
determine virtual item exchange schemes for the virtual objects in the item exchange state based on the difference information; and
present the first virtual item exchange scheme on the user interface, wherein the first virtual item exchange scheme includes object information of another virtual object in the item exchange state, and the predicted virtual item quantity change for the first virtual object.

14. The apparatus according to claim 13, wherein the presentation code is further configured to cause at least one of the at least one processor to:
identify a to-be-exchanged virtual item within the virtual camp based on the difference information, the to-be-exchanged virtual item being a virtual item having an actual possession quantity greater than an upper quantity limit for at least one virtual object in the item exchange state;
determine a virtual item allocation quantity of the to-be-exchanged virtual item among the virtual objects in the item exchange state; and
generate the virtual item exchange schemes for the virtual objects in the item exchange state.

15. The apparatus according to claim 14, wherein based on at least two virtual objects being in the item exchange state within the virtual camp, the presentation code is further configured to cause at least one of the at least one processor to:
determine a lack quantity and a possession quantity of the to-be-exchanged virtual item for the virtual objects in the item exchange state based on the type of the to-be-exchanged virtual item; and
determine the virtual item allocation quantity of the to-be-exchanged virtual item between the virtual objects in the item exchange state based on an exchange quantity of the to-be-exchanged virtual item, the lack quantity for each virtual object, and the possession quantity for each virtual object.

16. The apparatus according to claim 14, wherein the presentation code is further configured to cause at least one of the at least one processor to:
prioritize allocation to a first target virtual object having a lower possession quantity of the to-be-exchanged virtual item than other virtual objects lacking the same to-be-exchanged virtual item; and
in a case that the first target virtual object and at least one other virtual object have equal current possession quantities of the to-be-exchanged virtual item, prioritize allocation to whichever virtual object has a greater lack quantity of the to-be-exchanged virtual item.

17. The apparatus according to claim 13, wherein based on at least two other virtual objects being in the item exchange state within the virtual camp, the program code further comprises:
selection code configured to cause at least one of the at least one processor to receive a selection of target object information from the object information included in the first virtual item exchange scheme; and
target code configured to cause at least one of the at least one processor to present, on the user interface, a target virtual item exchange scheme configured to indicate a predicted virtual item quantity change for the first virtual object resulting from virtual item exchange between only the first virtual object and a virtual object corresponding to the selected target object information.

18. The apparatus according to claim 11, wherein the program code further comprises:
position code configured to cause at least one of the at least one processor to obtain position information of the virtual objects in the item exchange state in a virtual environment;
location code configured to cause at least one of the at least one processor to determine a target meeting location based on the position information and attribute values of the virtual objects in the item exchange state;
place code configured to cause at least one of the at least one processor to display, on the user interface, a place control configured to initiate coordination of movement to the target meeting location within the virtual camp; and
map code configured to cause at least one of the at least one processor to display location information of the target meeting location on a virtual map based on a trigger operation for the place control, wherein the location information guides the virtual objects in the item exchange state to converge at the target meeting location for performing virtual item exchange.

19. The apparatus according to claim 11, wherein the display code is further configured to cause at least one of the at least one processor to:
obtain an actual possession quantity and an upper quantity limit of a virtual item corresponding to the first virtual object based on a viewing operation for the user interface;
determine difference information for the first virtual object based on comparing the actual possession quantity to the upper quantity limit for each virtual item type;
display the difference information on the user interface; and
display the exchange request control on the user interface in a case that the actual possession quantity of at least one virtual item type is less than the corresponding upper quantity limit.

20. A non-transitory computer-readable storage medium, storing computer code which, when executed by at least one processor, causes the at least one processor to at least:
display, on a user interface of a first virtual object, an exchange request control configured to initiate a virtual item exchange request within a virtual camp;
control the first virtual object to enter an item exchange state based on a trigger operation for the exchange request control; and
present, on the user interface, a first virtual item exchange scheme configured to indicate a predicted virtual item quantity change for the first virtual object resulting from exchange of virtual items within the virtual camp.
